(19) United States
(12) Patent Application Publication
(10) Pub. No.: US 2009/0106846 A1
(43) Pub. Date: Apr. 23, 2009

(54) SYSTEM AND METHOD FOR DETECTION AND MITIGATION OF IDENTITY THEFT

(75) Inventors: Dennis J. Dupray, Golden, CO (US); Eric Richard Lunstrum, Westminster, CO (US); Daryl Yurek, Denver, CO (US); Justin Yurek, Denver, CO (US)

Correspondence Address: SHERIDAN ROSS PC, 1560 BROADWAY, SUITE 1200, DENVER, CO, 80202, US

(73) Assignee: Identity Rehab Corporation, Denver, CO (US)

(21) Appl. No.: 12/253,725

(22) Filed: Oct. 17, 2008

Related U.S. Application Data
(60) Provisional application No. 60/982,000, filed on Oct. 23, 2007.

(51) Int. Cl. G06F 11/30

(52) U.S. Cl. 726/26

(57) ABSTRACT

An identity theft and identity repair system and method is disclosed that uses public access databases to identify changes in the records of a person to detect and mitigate attempts of identity theft against the person. Unidentified data or changes in the person's name, address, social security number or phone number are used to determine possible attempts of identity theft against the person. Once a correct baseline of a person's publicly available personal information has been established, this information baseline is used to automatically monitor the person's public records on a periodic basis, notify the person of any detected changes which may be caused by the person or an imposter in an attempted identity theft. If identity theft is suspected, the system and method initiates a detailed analysis of the person's publicly available personal information to determine the extent of the (any) identity theft. A further option of the present system and method is to initiate needed corrective repairs.

### RELATED APPLICATIONS

The present application claims the benefit of U.S. Provisional Patent Application No. 60/982,000 filed Oct. 23, 2007 which is fully incorporated by reference herein.

### RELATED FIELD OF THE INVENTION

The present invention relates to an identity theft and repair system and method, and in particular, to such a system and method for timely detecting a plurality of different types of identity theft for a user, once the user's identity is appropriately verified. More particularly, the present system and method periodically determines whether there are one or more discrepancies between data that is known to be correct for the user, and newly obtained user related data that may be also related to a theft of the user's identity, wherein such discrepancies may be indicative of identity theft.

### BACKGROUND

Identity theft is an insidious crime that harms individual consumers and creditors. Identity theft is a crime that occurs when individuals' identifying information is used without personal authorization or knowledge in an attempt to commit fraud or other crimes.

In 2005 and 2006 alone, hundreds of organizations disclosed security breaches of a total of more than 100 million records containing consumers'² personal information that could be used in identity thefts. Also in that time period, other threats to peoples' identity surfaced, including large-scale mail theft³. One seeming reaction to these events is that sales of personal shredders increased 20-25% from 2002 to 2005⁴.

There has been extensive proliferation of identity theft over the last decade, costing consumers $56.6 billion dollars or $6,383 per individual in 2006 according to The 2006 Identity Fraud Survey Report (Council of Better Business Bureaus and Javelin Strategy & Research). The emotional impact of identity theft is harder to quantify but has been described by some victims as “financial rape.”

There are three primary forms of identity theft:
Identity thieves use financial account identifiers, such as credit card or bank account numbers, to commandeer an individual's existing accounts. ID thieves use this information to make unauthorized charges or withdraw money.
Thieves use accepted identifiers like social security numbers to open new financial accounts and incur charges and credit in an individual's name, but without that person's knowledge.
Thieves obtain individuals identifiers to secure social security cards, driver's licenses, birth certificates and use that information in the act of a crime. When thieves are then caught, they provide law enforcement with the false identification and leaving the actual person vulnerable to criminal prosecution.

Almost anyone can be a target of identity theft, but some individuals are at higher risk than others, and some areas of the country may be also more likely to be targeted than others.

A 2006 Harris Interactive poll showed that people with income over $75,000 are 42% more likely to sign up for a credit monitoring service than average, that people with a college degree are twice as likely to sign up for a credit monitoring service as those with just a high school diploma, and that people aged 45-54 are 53% more likely to sign up for a credit monitoring service than average. Additionally, people in certain areas of the country are more likely to be targeted for identity theft than others. The highest frequencies of identify theft occur in the West and Southwest portions of the U.S.

Fereral Trade Commission, Jan. 1-Dec. 31, 2005

| | |
|---|---|
| Phoenix-Mesa-Scottsdale | 17 |
| Las Vegas-Paradise | 15 |
| Riverside-San Bernardino-Ontario | 14 |
| Dallas-Fort Worth-Arlington | 14 |
| Los Angeles-Long Beach-Santa | 13 |
| Miami-Fort Lauderdale-Miami | 13 |
| San Francisco-Oakland-Fremont | 13 |
| Houston-Baytown-Sugarland | 12 |
| San Diego-Carlsbad-San Mancos | 12 |
| San Antonio | 11 |
| Denver-Aurora | 11 |

Credit report monitoring services have been positioned as the first consumer product to protect against identity theft. Rapid adoption within the last five years has resulted in a cumulative number of monitoring subscribers of over 17 million consumers. Credit monitoring has become a nearly $1 billion industry and growing¹. However, there is a need for a service that can offer existing credit report monitoring subscribers several additional benefits not readily available through traditional monitoring services, including:
Comprehensive protection of monitoring data changes from thousands of sources beyond the three credit reporting agencies,
More frequent scans of identity foundation data,
Expert review of all alerts to eliminate false alarms,
Fraud alerts on applicable reports,
Option to fully scope data intrusions immediately upon detection, and,
Full service restoration option upon discovery of unauthorized access.

Accordingly, it is desirable to have an identity theft detection and mitigation system that is more comprehensive than currently exists so that various types of identity theft can be detected, if possible, prior to extensive damage to an individual's personal identity records.

### SUMMARY

An identity theft detection and mitigation system and method is disclosed herein that uses data retrieved from a potentially large number of public and/or proprietary databases to identify changes in the personal records of each person of a plurality of persons (i.e., clients subscribing to the services of the present system and method) in order to detect and mitigate attempts of identity theft against the person. Various models of identity theft may be incorporated into the identity theft detection and mitigation system and method disclosed herein, wherein each such model may be used to identify one or more types of identity theft. For example, one such model may be provided to detect unverified client personal data, and/or changes in a client's name, address, social security number, birth date or phone number in order to determine whether a possible attempt of identity theft against the client has occurred (or is occurring). In most such models of identity theft, a collection of core personal data item types (e.g., name, social security number, Medicare identification, pilot license, educational background, etc.) is identified as fundamental data types, wherein at least one such data type must have its value changed or a new value added for an identity theft to be perpetrated that could be detected by the model. Accordingly, once a correct collection of values for such core or baseline personal data item types has been established for a given model, this baseline information may be used to automatically monitor the client's records in various public and/or proprietary databases on, e.g., a periodic (monthly) basis for detecting changes that may be indicative of identity theft. One embodiment of the present identity theft detection and mitigation system, notifies a client of each detected change and/or additions to at least the client's baseline information. However, other models may only notify the client of a potential identity theft being detected when, e.g.,:
(a) a pattern of incorrect personal information changes appears to be developing,
(b) when more than one of the baseline data types have new or changed values, or
(c) previously correct personal information which is no longer correct is being used or accessed again.

If a client's identity is detected as likely or actually stolen, the present system and method may initiate a detailed analysis of the client's available personal information to determine the extent of the (any) identity theft. A further option of the present system and method is to initiate needed corrective repairs.

Although automated consumer access to credit report databases as well as other consumer information databases, such as department of motor vehicle databases, has become widespread such access alone without expert analysis of this data provides limited additional value to consumers. The present identity theft and identity repair system and method may provide comprehensive access to consumer databases for viewing, analyzing, and correcting consumer information in a manner that has not been previously offered to consumers.

Non-profit consumer advocacy groups and the Federal Trade Commission provide Do-It-Yourself provide assistance to persons that believe their identity has been stolen. However, the navigation, analysis, and/or correction of databases having personal information is very difficult and very time consuming. Alternatively full service professional resolution, which requires a power of attorney from the consumer is relatively new and can be expensive. The present identity theft and identity repair system and method can provide faster and more comprehensive results without the need for full service professional resolution. In particular, the present system and method offers the following advantages:
Automatic access to a consumer's public and private records for, e.g.,
   (a) detection of identity theft in a large number of consumer information domains, including identity theft directed to consumer credit, medical history, criminal history, etc.
   (b) correcting and/or updating a consumer's records without the consumer initiating such tasks. For example, if a consumer changes his/her medical insurance provider, then upon detecting such a change in the medical records by databases accessed by an embodiment of the present identity theft detection and mitigation system, a notification may be provided to the consumer for his/her confirmation.
Identity theft resolution procedures that may access and correct consumer information in a plurality of consumer related databases, wherein such correction may need to follow certain legal procedures not readily available or known to most consumers.
Since most consumers do not have adequate time to aggregate and sufficiently understand all the necessary information to perform their own identity recovery/correction, embodiments of the present identity theft and identity repair system and method may provide automated processes for performing such identity recovery/correction for a consumer, wherein the consumer is notified as recovery/corrections are performed, and informed of preventative measures the consumer can take. Additionally, consumers can provide or designate various predetermined rules/processes to be performed during recovery/correction, including, e.g.,
   (a) Notifying a military officer, governmental official, or judicial magistrate.
   (b) Performing such rules/processes depending on the type of identity theft detected, e.g., for a detection of medical identification theft, notification of the consumer's medical insurance carrier.
   (c) Performing a default set of one or more tasks that are specific to the type of identity theft detected.
   (d) Allowing the consumer to modify the order of and/or which of the tasks in a default set of tasks to be performed, e.g., notifying a mortgage company holding a loan obtained by an imposter prior to notifying the Internal Revenue Service so that appropriate documentation can be obtained from the mortgage company.

The present identity theft and identity repair system and method provides consumers with access to their corresponding consumer information, and may initiate activities for wholesale correction of a group of consumers whose identities have been stolen similarly. Moreover, the present system and method may rate the proficiency of various consumer data tracking entities in their ability to perform such tasks as detect and/or correct personal data inaccuracies, and to expedite performance of such tasks. Note that such ratings may be used in determining how to correct certain types of identity theft. For example, if it is known that a particular medical insurance database provider is relatively slow in making corrections if such corrections are presented directly to the entity, but much faster if such corrections are provided via the entity's parent company, then the present system and method may use such information for supplying the corrections to the parent company.

In at least one embodiment of the present identity theft and identity repair system and method, the following steps are performed for detecting identity theft:
(A) verifying a client's identity;
(B) receiving from one or more informational sources, personal client information depending upon an extent of verification of the client's identity;
(C) presenting the personal client information to the client for obtaining corrected personal client information;
(D) receiving additional personal client information from the one or more informational sources; and
(E) determining whether there is a discrepancy between the corrected personal client information and the additional personal client information, wherein the discrepancy is an indication of incorrect data in the additional personal client information;
(F) determining, when the discrepancy is determined to exist, a result indicative of a likelihood of identity theft occurring, the result being dependent upon an evaluation of the discrepancy, the evaluation including a step of combining a plurality of weighted measurements, each measurement for indicative of an occurrence of an identity theft related factor in the discrepancy, each of the weights indicative of a relative effectiveness for predicting whether identity theft is occurring or is likely to occur;
(G) selecting data for requesting further more detailed information personal client information to be retrieved from the one or more informational sources or additional informational sources for assisting with identity theft analysis;
   wherein the step of selecting is dependent upon at least one value of the result; and
(H) providing the client with information related to identity theft when the discrepancy is determined to exist.

In at least one embodiment of the present identity theft and identity repair system and method, the following steps are performed for detecting identity theft:
(A) receiving, from one or more informational sources, personal information identifying a client;
(B) detecting one or more discrepancies between the personal information, and client information known to be correct for the client;
(C) determining a likelihood that a theft of the client's identity is occurring or has occurred;
   wherein the step of determining includes determining one or more of:
      (a) a number of the discrepancies between the personal information and the client information;
      (b) whether a first instance of a value of the personal information, detected when determining at least one of the discrepancies, is a typographical variation of a second instance of the value, and wherein the first and second instances are not a result of a common act by the client; and
      (c) whether there is a common value, detected in first and second records of the personal information, wherein:
         (i) the common value is not correct for the client, and
         (ii) the first and second records are not a result of a single act by the client.

Additional features and benefits of the present disclosure are provided in the Detailed Description herein below, and the accompanying drawings. In particular, not all novel aspects of the present disclosure may be mentioned in this Summary section. However, such lack of description in the present Summary section is not to be taken as an indication, implication or suggestion that such aspects are of lesser importance or less novel than those aspects described hereinabove.

### BRIEF DESCRIPTION OF THE DRAWINGS

FIG. 1 shows a high level flowchart of the processing performed by the present identity theft detection and mitigation system and method.

FIGS. 2A and 2B show a more detailed flowchart of the processing performed by the steps of FIG. 1.

### DETAILED DESCRIPTION

The present identity theft detection and mitigation system and method includes three high level services and/or subsystems, these are: (a) an assessment service/subsystem that assesses a client's risk of becoming an identity theft victim, and alerts the client of his/her risk, (b) a comprehensive retrieval service/subsystem that may be activated when, e.g., a high risk is indicated by the assessment service/subsystem, wherein this retrieval service/subsystem retrieves, from public and/or proprietary databases, substantial additional detailed personal information about the client for more precisely identifying the likelihood and scope of a potential identity theft, and (c) an identity rehabilitation service/subsystem to assist and/or automate in mitigating damage due to identity theft and recovery therefrom.

The assessment service/subsystem may provide comprehensive identity theft monitoring from thousands of public and private databases, including all three major credit bureaus, as well as criminal and legal databases. In at least one embodiment, the assessment service/subsystem monitors key components of a customer's personal information, including:

(i) First and last name,

(ii) Address,

(iii) Social security number,

(iv) Date of birth,

(v) Phone number,

(vi) Credit inquiries,

(vii) Number of credit accounts,

(viii) Number of bank accounts, and

(ix) Bounced checks.

The assessment service/subsystem may regularly receive updates from, e.g., a large plurality public and/or proprietary databases that provide changes to a client's personal information such as the information in (i) through (ix) above. Further, the assessment service/subsystem analyzes the retrieved client information for detecting identity theft activity. In particular, one or more identity theft detection models may be used for detecting various types of identity theft from the information received.

The comprehensive retrieval service/subsystem queries databases in one or more (preferably all) of the following areas for signs of identity theft.
(i) Credit Records:
   a. May retrieve personal credit history and rating that identifies the client,
   b. May additionally retrieve/determine: personal interest rate and loan approval likelihood;
(ii) Checking Account Records:
   a. May retrieve the client's check writing and debit transactions,
   b. May additionally retrieve information related to: check writing approval on retail purchases and/or the ability to open checking/debit accounts;
(iii) DMV Records:
   a. May retrieve the client's license, vehicle registration and driving history,
   b. May additionally retrieve the client's: auto insurance rates, ability to obtain/renew a drivers license, employment eligibility;
(iv) Medical Records:
   a. May retrieve the client's insurance information referring to health and/or longevity,
   b. May additionally retrieve the client's: health insurance rates and employment eligibility;
(v) Social Security Identification Records:
   a. May retrieve client information for verifying social security number and associated address history,
   b. May additionally retrieve the client's: benefit eligibility, status;
(vi) National Security Records:
   a. May retrieve information related to the most wanted by Interpol, FBI, United Nations and terrorism association,
   b. May additionally retrieve: the client's ability to travel, both domestically and internationally;
(vii) Criminal Records:
   a. May retrieve the client's criminal information that identifies, e.g., sex offender information that may identify the client, Department of Corrections information identifying the client, arrests and national warrant records identifying the client,
   b. May additionally retrieve: employment, personal freedom and standard of living for the client;
(viii) Court Records:
   a. May retrieve voter registration, bankruptcy, civil, and/or appellate records identifying the client,
   b. May additionally retrieve: employment, financial viability and lien complications that identify the client.

Additionally, as the need arises, the comprehensive retrieval service/subsystem may retrieve more detailed personal information, such as a client's:

phone records,

utility records, and/or

hunting and fishing licenses, etc.

The identity rehabilitation service/subsystem can be a very complicated process. Studies indicate that an individual may spend in excess of 330 hours attempting to repair damages by navigating through a maze of creditor reports, governmental reports, criminal reports, medical reports, etc.

The identity rehabilitation service/subsystem utilizes a power of attorney provided by a client so that damaged or incorrect client records can be corrected. An important aspect of the identity rehabilitation service/subsystem is the certification of records as false or damaged, wherein such certification includes, e.g., an FTC Identity Theft Affidavit and a copy of a police report.

The identity rehabilitation service/subsystem may acquire source documents on each fraudulent or incorrect item, or affidavits signed by the victim if source documents are not available. Automated forms coupled with various certification documents are then sent to the appropriate parties for database correction.

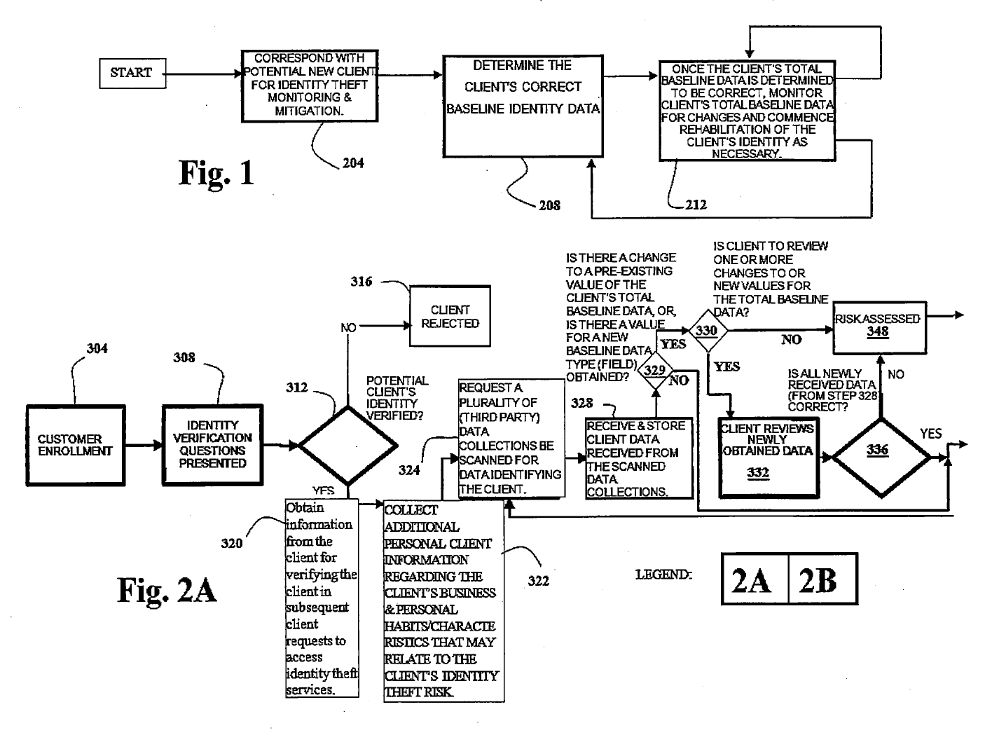

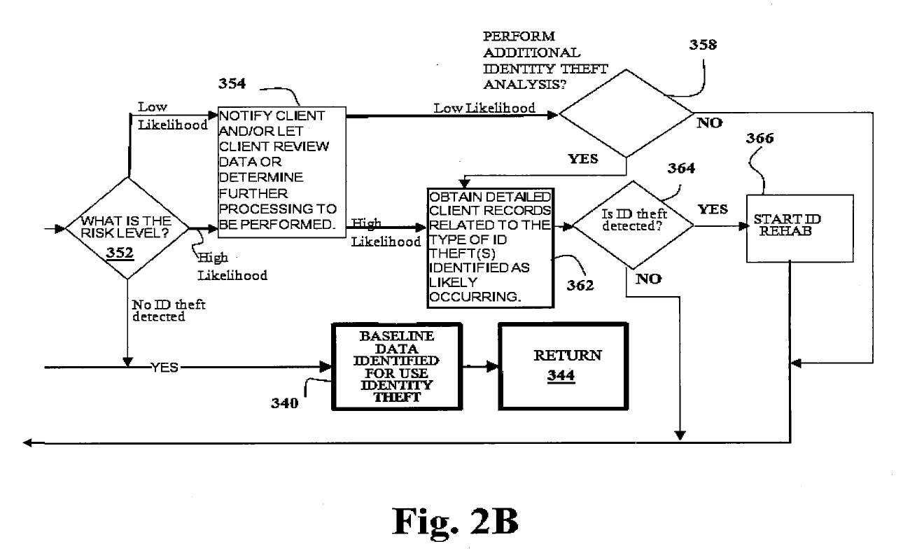

FIG. 1 shows an embodiment of the high level steps performed by the present identity theft detection and mitigation system/service. In step 204, initial correspondence with a potential client is performed. This step includes the steps 304-316 of FIG. 2, and further details of this step 204 are provided in the description of steps 304-316 hereinbelow. Subsequently, in step 208, a collection of correct information about the client is determined for subsequent use in identifying or detecting identity theft. Note that such information includes baseline or core information needed for activating one or more identity theft models. Note that additional baseline or core information for additional identity theft detection models may be obtained subsequent activations of step 208. In one embodiment, step 208 includes steps 320-344 of FIG. 2. In step 212, once a threshold amount of the client's baseline data is determined to be correct (for one or more identity theft detection models), identity theft monitoring, detection, and if the client requests, rehabilitation of the client's identity information is performed. Step 212 includes the steps 348-366 of FIG. 2 described hereinbelow. Note, that two embodiments are provided of step 212. In a first embodiment, for each (periodic) (re)scan of client information retrieved from the databases scanned, the client must inspect at least any client identity values obtained that were previously unknown, and make a determination as to which data items retrieved are correct and which are incorrect. In a second embodiment, after (re)scanning databases for client information such a determination as to whether there is incorrect information may be performed automatically.

The steps of FIG. 2 are described as follows.

### Customer Enrollment (Step 304)

A client's personal and payment information is taken thru a call center or website. The payment information for the present identity theft detection and mitigation system/service is processed.

### Identity Verification Questions Determined (Step 308)

In addition to the client's name, address, social security number, date of birth, phone number, and email address, various additional items of personal information may be requested. Such additional information serves two purposes. First, it may allow the system to immediately gather additional information about the client to be used in verifying the user's identity. Accordingly, since most clients are likely to initially contact the present identity theft detection and mitigation system via the phone and/or the Internet, the present disclosure describes advanced and novel techniques for further assuring that the client is who he/she claims to be since it would be particularly problematic if an imposter with partial information about another person succeeded in using the present system to obtain additional information about the other person to assist in illicitly obtaining additional information about the other person. Secondly, once there is sufficient satisfaction that the user is who he/she claims to be, such additional information may be used to request further personal information and/or to verify such additional information is correct or suspect.

Once the potential client has provided the above requested personal information, this information may be used to perform a search of online databases for obtaining the further information for further identifying the potential client. The online databases accessed may be publicly available, may be proprietary databases, and/or may require the potential client's permission. Upon receiving such further information, a plurality of questions to be posed to the potential client may be formulated from this further information, wherein a correct answer to each question would be unlikely to be given by an imposter. In one embodiment, such “challenge” questions may relate to:
(1) The credit/debit cards the potential client has, e.g., such a challenge question may be: “What credit cards do you currently use?”.
(2) The name of a mortgagor for a property in the potential client's name.
(3) A street address where a client may have lived.
(4) A prior phone number.

In one embodiment, three such challenge questions regarding personal history and/or information of the potential client are presented to the potential client in order to at least provisionally verify the potential client's identity.

It is believed that replies from a potential client to questions/requests such as those above provide sufficient information to provisionally determine whether the potential client is who he/she claims to be. In particular, records publicly available via the Internet may be queried for determining whether there is sufficient consistency between the publicly available records and the potential client's responses.

### Identity Verification (Step 312)

In the present step a determination is made as to whether the identity of the potential client is sufficiently verified to proceed with further processing for providing identity theft services to the potential client.

In one embodiment, if the potential client incorrectly answers no more than 1 out of 3 of the challenge questions formulated in step 308, then it may be presumed that the identity of the potential client has been appropriately verified. However, if the potential client incorrectly answers 2 or more of the three questions, then a series of at least 2 additional challenge questions may be presented to the potential client, and in one embodiment, all such additional challenge questions must be answered correctly to proceed with obtaining identity theft services. Accordingly, if a determination is made that the potential client is not sufficiently verified, then in step 316 the potential client is rejected and no further processing is performed. Alternatively if it is determined that the potential client is sufficiently verified, then processing continues with the steps described hereinbelow.

In one embodiment, assuming the potential client successfully demonstrates his/her identity above, then the potential client may be designated as a “provisional” client, wherein identity theft services are provided to the extent that: (i) no additional non-public personal information about the actual person is provided to the provisional client, and (ii) no requests will be generated for requesting changes to third party records (such as credit records, address records, etc.). Such “provisional” client status may be maintained until there is further verification that the client is who he/she says he/she is. Accordingly, the provisional client may be given notifications such as whether the present identity theft detention and mitigation system/service detects a likelihood of identity theft, and, e.g., variations in the provisional client's name, address, etc. found in publicly available databases.

Additionally, a provisional client may be informed that for each of the provisional client's publicly available current address(es), likely current address(es), and/or past address(es), for a predetermined time period (e.g., the past two years), and/or for a predetermined number of previous addresses (e.g., two previous addresses for the provisional client), a letter will be sent to the provisional client, at such addresses, informing him/her that the present identity theft detection and mitigation system/service may be actively monitoring his/her identity, and possibly providing him/her with additional information specific to the provisional client's identity. Moreover, such letters may state that if such actions are deemed illegitimate, then the person to which the letter is addressed should contact the operator of the present identity theft detection and mitigation system/service. Note, that this latter technique has the benefit in that it inhibits an individual from attempting to illegitimately use the present system/service to further an identity theft in progress since presumably at least one such letter would be received by the actual person that the potential client is representing him/herself to be. Moreover, this technique may be extended to other ways of contacting the actual person in the event that the potential client is an imposter. For example, since publicly available records can be searched for additional phone numbers, email addresses, etc. that may correspond with the identity of the actual person (e.g., correspond with the person's name and a known property address for the actual person), individuals at such alternative contacts can also be notified, and requested to contact the present identity theft detection and mitigation system/service if the person contacted believes the potential client is an imposter. Thus, an actual person may be contacted timely in multiple ways so that any improprieties can be identified prior to any release of additional personal non-public information to the provisional client when he/she becomes a non-provisional fully verified client of the present system/service. Thus, in one embodiment of the present system, if there is initial satisfaction of the potential client's identity, then the potential client may be offered services as a provisional client until, e.g., a predetermined time has elapsed after such contacts of one or more current addresses of record (and/or of record addresses in the recent past) without any dispute in regarding providing identity theft services to the provisional client. Of course, other techniques may be also available for such a provisional client to verify him/her self, including, e.g., an in person visit at an office for the present system/service and thereby providing sufficient identity documentation (e.g., legal authentication documents) and/or, e.g., bio-metric identification such as finger prints, etc.

### Determine Client Information For Subsequent Client Contacts (Step 320)

In the present step client specific information is obtained for verifying the client's identity for use in subsequent attempts by the client to access the present identity theft detention and mitigation system/service. Note, in one embodiment, such specific information may in the form of a username and password. Alternative/additionally, client selected challenge questions may also be presented to the client for re-verifying the client's identity in subsequent accesses of the present system/service. In one embodiment, voice recognition and/or bio-metric characteristics of the client may be used to verify the client. For example, in the re-verification process, the client may be asked to repeat a phrase or sentence that is dynamically generated at the time the client requests a subsequent access to the present identity theft detention and mitigation system/service.

### Collect Additional Personal Client Information From the Client (Step 322):

The more personal information that the present identity theft detention and mitigation system/service obtains about the (provisional or non-provisional) client, the better, since the present system/service will be better able to distinguish between an actual identity theft and a false-positive therefor. For example, if the present system/service is supplied with information indicating that the client does not need to renew his/her driver's license within the next two years, then a driver's license renewal within the next two years may be indicative of an identity theft in progress.

Collecting extensive personal information from a client may be at least time consuming for the client if not onerous. Accordingly, embodiments of the present identity theft detection and mitigation system/service may attempt to alleviate client effort in providing such information by automatically populating as much personal information as can be obtained from, e.g., publicly available information sources, and then requesting the client to verify such information. Thus, for example, if the client states general information such as he/she has vehicles registered in Colorado and Mexico, then the present system/service may access vehicle registration databases in both Colorado and Mexico, populate a form with such information and display the populated form to the client for his/her verification. Alternatively, all vehicles, e.g., in the U.S., registered to a variation of the client's name may be collected, and upon presenting to the client the states that such vehicle registrations were obtained, the client may then identify those states where he/she actually has vehicles registered. Subsequently, more detailed information about the vehicle registration(s) in such client identified states may be provided to the client for his/her verification or disavowal or indicate an apparent typographical error.

Note that such a technique of providing a client with progressively more detailed personal information obtained from publicly available data sources, and allowing the client to comment on data records in the information (e.g., categorize such records as one of: (i) applicable to him/herself and correct, or (ii) applicable but contains typographical errors and is not likely to be used in identifying another person, or (iii) does not appear to be a typographical error, and not applicable to him/herself) is believed to provide the following benefits.

A first benefit is that the client is supported in providing and/or identifying personal information that applies to him/herself. Thus, there is a reduced amount of information that the client may need to enter, and more complete client information may be obtained. For example, a client may have forgotten about a vehicle that he/she has registered in another state, but may remember such once notified that a vehicle appears to be registered to him/her in the other state.

As a second benefit, the present identity theft detention and mitigation system/service may attempt to assist the client by making an initial assessment of each data item in the information the client is to review. For example, duplicates of the same data item for a client may be retrieved from different databases. Accordingly, the present system/service may filter out duplicates so that the client need only review a single copy of such a data item. Moreover, in the event that same client information is clearly being described by two different data items, wherein the data items vary, the present system/service may list both data items adjacent to one another with indications of how they differ.

As another benefit, if a client is allowed to identify particular data fields that are incorrect, then such information may be stored and used to dynamically and automatically categorize additional data items of the personal information. Thus, if a client indicates that a particular data item is not applicable, and additionally indicates that the name field is not applicable, and the address field is applicable but contains a typographical error, then an identical name and address field may be automatically be provided with the same labels. Accordingly, a data item may be labeled as not applicable prior to the client reviewing the data item. Moreover, if during the review process, the client changes his/her mind about the labeling of a particular value of a field (e.g., a variation of the client's name), then the client may be alerted of the (any) other data items having the particular value that may be automatically relabeled so that the client is able to review these other data items as well. Of course the client may also identify exceptions to prevent such automatic relabeling, e.g., a client may purposefully use his/her initials in his/her name on only one particular credit card; thus, such initials found in a name field unrelated to the particular credit card may be identified as not applicable, whereas the entire data item for the particular credit card may be identified as applicable.

As another benefit, for data items presented to the client that the client indicates do not apply to him/herself, such data items may be useful in determining whether an identity theft is in progress. Each of the data items that the client indicates is not applicable may fall into one of the following categories:
(i) Properly and Legitimately Identifies Another: Note that in general data items in this category should be rare in that the retrieval of the data items from their data sources should be performed in manner where one or more of the fields in each retrieved data item exactly matches the client's known information (e.g., name, social security number, criminal record, etc.), and one or more other field values (e.g., address) appears to be at most a typographical variation of the client's known information;
(ii) Client Mistake: Such a data item actually is applicable to the client, but the client does not recognize the data item as applicable, e.g., due to the client not recalling the event resulting in the data item (e.g., client not recalling registration of a vehicle perhaps due to the description of the vehicle being incorrect from e.g., typographical errors, even though the vehicle license number is correct), or due to the data item being simply unrecognized although entirely correct (e.g., due to the complexity of the data item or the complexity of the client's identity information) or due to a lengthy passage of time since the event occurred;
(iii) Mistake by a Recording Entity: Such a data item is legitimately applicable to another person with, e.g., similar information; however due to, e.g., typographical errors, some ambiguity in the identity of the person to which the data item should apply has resulted; e.g., a pilot certification record may have the client's correct name and address, but the client's social security number may be that of another person with the same last name; and
(iv) Identity Theft: Such a data item(s) is indicative of a purposeful improper change in the client's identity, and may be indicative of an attempted or in progress theft of the client's identity.

Accordingly, the present system/service may flag or otherwise identify such inapplicable data items that the client indicates should not apply to him/herself so that these data items can be appropriately addressed as described further hereinbelow.

Briefly, however, an analysis may be performed on these anomalous data items which the client indicates should not apply to him/herself for obtaining at least a current likelihood of identity theft. In one embodiment, there may be one or more computational models for determining the same type of identity theft and/or different types of identity theft. For example, there may be an identity theft model for detecting impersonation of a client for purchasing a property in the client's name, and a different model for detecting illicit use of a client's professional or educational background. Moreover, there may be a plurality of models for detecting, e.g., a theft of a client's identity for obtaining credit wherein one such model assumes the imposter first attempts to obtain a driver's license in the client's name, and then uses the new driver's license (and likely the client's social security number) in filling out a new credit card application, and another such model assumes the imposter first attempts to open a bank account in the client's name, then uses the new bank account in filing out a new credit card application.

Thus, the above described user interaction technique for obtaining potentially extensive personal information from a client may be applied for detecting particular types of identity theft. For example, the above described interaction technique may be applied to medical identity theft only if the client indicates that he/she wishes to supply additional personal information that may assist in detecting medical identity theft. Accordingly, the client may choose to provide and/or verify:
(a) no additional personal information beyond, e.g., name variations used, aliases, current address, social security number, date of birth, phone number, email address;
(b) additional general personal information that may be related to various types of identity theft (e.g., previous addresses, parents' address(es), addresses of relatives, driver's license identification, etc.); and/or
(c) personal information that may be related to specific types of identity theft, e.g., professional registrations (e.g., medical or legal state registrations to practice), medical insurance information.

Note that such additional personal client information may be captured in two or more client sessions, e.g., via the Internet, wherein in the first such session the client may be a provisional client, and accordingly, information in non-public data sources will not be accessed in the above described techniques for obtaining additional client information. However, once the client's identity is further verified and the client becomes a non-provisional or regular client, then the client may participate in a second session that provides the client with access to the client's personal information obtained from non-public data sources (assuming the present system/service obtains any client permissions necessary to access such non-public information).

Accordingly, additional information related to one or more of the following may be requested of the client:
(1) Any previous theft of your identity?
   a. If so, please describe. When? What portion of your identity was illicitly used?
(2) List at least two previous addresses (if not already known).
(3) List all addresses from which you can receive mail, and any phone number at each address.
(4) List any properties having your name on the title as an owner.
   a. Do you have any outstanding legal issues related to any property? If so what?
(5) List all vehicle(s) registered in your name.
   a. Do you have any outstanding legal issues related to any vehicle? If so what?
(6) What is the highest educational degree you have? From what educational institution? Identify at least one school you attended.
(7) Driver's license information. For example, the following questions/requests may be asked of the client:
   a. In what state(s) (and/or country or countries) do you have a driver's license? For each such state and/or country, please provide your driver's license identification. Please give an expiration date for each driver's license.
   b. Do you have any outstanding legal issues related to any such driver's license? If so what?
(8) Request for personal medical information. For example, the following questions may be asked of the client:
   a. Please list all current medical related identifications you have (e.g., Medicare, Medicaid, client medical insurance identification(s), etc.).
   b. Please list all persons covered on each (any) medical insurance/assistance programs for which you are also covered or you are identified thereon.
   c. What hospital(s), doctor(s), and/or other medical professionals do you visit/use, or others visit/use for which you are responsible?
   d. Who else (if anyone) has access to your personal medical identification information (e.g., insurance, Medicare, Medicaid, etc.)?
(9) Client civil and/or criminal information. For example, the following questions may be asked of the client:
   a. Do you have any outstanding legal issues related to any such civil and/or criminal matters? If so what?

An important feature of the present identity theft detection and mitigation system and method is to provide clients with identity theft alerts that are more relevant to each client's particular circumstances. In particular, the present identity theft detection and mitigation system and method obtains a much larger amount of client specific information in order: (i) to reduce the number of false positive identity theft notifications that clients need to address, and/or (ii) to detect actual identity thefts much earlier than prior art identity theft techniques. Accordingly, in step 322, the client may be requested to supply additional information regarding one or more of the following:
(a) Client characteristics that may assist in identifying additional data collections that might not otherwise be queried (e.g., due to the expense and/or complexity of querying such additional data collections). For example, for a client residing in the U.S. but having citizenship in Canada and maintaining a residence in Canada as well, it may be desirable to query certain Canadian national data collections that would not be queried for a client indicating that he/she has not traveled outside of the U.S. and has not resided in Canada. In another example, if a client is registered as a professional (e.g., a medical doctor, certified public accountant, lawyer, dentist, truck driver for large trucks, real estate broker, etc.) in one or more states, then particular data collections may be accessed that would not be accessed otherwise. For instance, for a medical doctor accepted to practice in the state of California, U.S., it may be prudent to access various medical professional databases to identify all U.S. state medical records that appear to identify the client. Accordingly, questions such as the following may asked of the client:
   (1) Client citizenship, residency, and travel information. For example, the following questions/requests may be asked of the client:
      (i) What countries do you have citizenship?
      (ii) What countries do you maintain a residence?
      (iii) Do you travel abroad? If so, to what countries? How frequently?
      (iv) Is there a maximum purchase limit you would make by credit or debit card when in a foreign country? If so, what is it?
      (v) Do you have a passport? If so, who has access to it?
      (vi) What states in the U.S. have you lived in?
      (vii) In what states/countries do you own property?
      (viii) In what states/countries do you have a driver's license?
      (ix) In what states/countries do you have any property registered? (e.g., aircraft, watercraft, automobile, etc.)?
   (2) What professional organizations are you a member of or what professional registrations do you hold or have held?
(b) The client's personal and business history, and/or habits, and/or purchasing patterns (collectively referred to “personal characteristics” herein), and/or information related to the client's environment and conditions thereof (e.g., personal information on associates, constraints on where large purchases are likely to take place, etc.). In particular, such personal characteristics and/or environmental information related to identity theft may be especially useful in identifying particular types of identity theft very early on, and/or reducing the likelihood of notifying a client of a potential (but not actual) identity theft. For example, it is known that as much as 40% to 50% of at least certain types of identity thefts are committed by individuals that are known to their victims, e.g., relatives, acquaintances, and/or business associates, etc. Thus, if a client is able to provide personal information (e.g., name, current and previous addresses, phone number, date of birth, criminal record information, occupation, business address, etc.) on persons known to the client, then at least for such persons that appear to be more likely to commit identity theft, certain identity theft rules or conditions (e.g., if-then rules or conditions) may be generated, wherein if one or more such rules are triggered or activated, then identity theft may be, e.g., more likely, and accordingly, the client is more likely to be notified. For example, if a client has had a relative (or close associate) living with him/her or has provided such a relative (or close associate) with access to sufficient personal information to perpetrate identity theft (e.g., the client's social security number, Medicaid information, medical insurance information, student identification, etc.), and the relative or close associate appears to be a likely candidate to impetrate an identity theft due to, e.g., a criminal or drug record, or financial difficulties in combination with an expensive medical condition, or a perceived animosity toward the client, then when such a person is identified by the client, the present identity theft detection and mitigation system and method may periodically query various public data collections for further information on the person, and then generate and install or suggest to the client certain rules or conditions that are more likely to detect if the person perpetrates an identity theft against the client. For example, a client that is handicapped or elderly or wealthy that requires, e.g., a live-in assistant wherein the assistant may receive a relatively low wage for his/her services, then such an assistant may be more likely to commit identity theft than someone else known to the client. This may be especially true if the assistant has a criminal record or drug abuse history and/or a member of the assistant's family has a criminal record or a drug abuse history. Accordingly, by accessing publicly available data collections (e.g., criminal record databases, driving record databases, etc.) such suspicious persons can be identified, and in some cases distinctions between the personal characteristics of the client and each such suspicious person may be used to detect a potential identity theft. For instance, if it is known that the client purchases prescriptions at a particular pharmacy, and such prescriptions are for blood pressure reducing drugs, then prescriptions for stimulants from a different pharmacy, and wherein an assistant to the client has a brother living at the same address as the assistant has a drug related conviction, then the client may be notified of a potential medical identity theft on the first occurrence of this scenario. As another example, consider a businessman who travels extensively and has a close nephew with access the businessman's residence while the businessman is traveling. If during some (periodic) query of the nephew's background the query shows that the nephew has filed for bankruptcy or is convicted of drunk driving or is identified as a defendant in a law suit, and a new credit card account is opened in the businessman's name, then the businessman may by notified as soon as the new credit card is activated. As another example, if the client indicates that it is very unlikely that he/she would make a real estate purchase in a state other than Colorado, and such a purchase in the client's name is detected in Florida, then the client may be immediately notified of a potential identity theft for obtaining a real estate mortgage.

Accordingly, as described hereinbelow, the present identity theft detection and mitigation system and method may use a sensitivity analysis of the conduciveness of a client's environment and personal characteristics for generally raising and/or lowering the likeliness of the client being alerted or notified of a potential identity theft. Additionally, such notifications to a client may also be provided with a description of why the notification is provided, thereby allowing the client to better understand the notification. Moreover, in one embodiment, such client specific personal characteristics may be used in combination with general identity theft patterns related, e.g., to particular types of identity theft as is described further hereinbelow.

Conversely, rules or conditions can be generated that reduce the likelihood of identity theft.

Thus, in addition to asking a client about specific data collections to be queries, step 322 may also inquire of the user about his/her personal characteristics, and environmental information via questions such as the following.
(1) Purchase habits/characteristics, e.g., when does the client expect to purchase a new car, house, boat or other large purchase, what is the maximum purchase that the client expects to be likely on a (or any particular) credit card,
   a. For each credit card
(2) Internet use. For example, the following questions/requests may be asked of the client:
   a. Do you purchase items via the Internet using credit/debut card information? If so, which cards? Is there maximum purchase limit for a single transaction you would make? For each card, please provide (if possible) a maximum purchase limit for the card for a single transaction and/or total Internet transactions, e.g., per month.
   b. What items/services do you purchase via the Internet? How frequently?
   c. Does anyone else purchase items on the Internet with your personal information?
(3) Client's acquaintances (acquaintances that might have access to the client's personal information, acquaintances with criminal records, acquaintances with drug or financial problems). Additionally, questions/requests such as the following may be asked of the client:
   a. Does any co-worker/colleague of the client have access to your social security number?
   b. Have you lived with any of the acquaintances? Which one(s)? Where?
   c. Where does each of the acquaintances live (e.g., city, state, and/or full address)?
   d. Do you, or are you likely to live with one or more acquaintances? Which one(s)?
   e. Have you previously lived with any relatives?
   f. What is the age of each acquaintance?
   g. Do any of these acquaintances have problems in one or more of the areas: drugs, finances, legal, medical, bankruptcy, etc.? Do any of these acquaintances have criminal records?
   h. Do you provide credit/debit card information to any of these acquaintances? If so, which acquaintance(s) and which credit/debit card information? And for each credit/debit card, what is a maximum credit/debut limit you would expect, e.g., per month?
(4) Relatives (e.g., children, (ex)spouse, siblings, parents, etc.). For example, the following questions/requests may be asked of the client:
   a. Where does each relative live (e.g., city, state, and/or full address)?
   b. Do you, or are you likely to live with one or more relatives? Which one(s)?
   c. Have you previously lived with any relatives?
   d. What is the age of each relative?
   e. Do any of these relatives have problems in one or more of the areas: drugs, finances, legal, medical, bankruptcies, etc.? Do any of these relatives have criminal records?
   f. Do you provide credit/debit card information to any of these relatives? If so, which relative(s) and which credit/debit card information? And for each credit/debit card, what is a maximum credit/debut limit you would expect, e.g., per month?

### Request Additional Client Information From Third Party Sources (Step 324)

In step 324, additional personal information identifying the client is requested from a potentially large number of publicly data collections. In one embodiment, approximately 1,000 or more distinct publicly available data collections are queried for personal information identifying the client. For example, although some of the following data collections may have been queried in step 308, substantially all of the following data collections may be queried for client information in step 324:
Equifax consumer credit database for obtaining:
   Client's credit report,
   Identifications of entities requesting the client's credit report;
TransUnion consumer credit database for obtaining:
   Client's credit report,
   Identifications of entities requesting the client's credit report;
Experian consumer credit database for obtaining:
   Client's credit report,
   Identifications of entities requesting the client's credit report;
Regional Bell Operating Companies and/or wireless phone companies for obtaining:
   Client's phone numbers;
National Change of Address NCOA database for obtaining:
   Client's previous address(es);
State and City Public Records for obtaining the following client information:
   Client name changes,
   Client variations in name,
   Client Address History,
   Client business associates of records,
   Client bankruptcies,
   Client birth certificate(s),
   Client businesses,
   Criminal records—city, state, county, federal,
   Client concealed weapons permits,
   Client driver's licenses,
   Client driving records,
   Client divorce record(s),
   Client FAA aircraft registration(s),
   Client FAA pilot license,
   Client hunting/fishing permits,
   Client liens & judgments,
   Client marriages,
   Professional licenses (e.g., engineering license, nursing license, etc.);
From additional government data collection (e.g., U.S. Federal data collections):
   Census data, e.g., related to the client's principal residence,
   Client passports;
In one embodiment data collections may be queried for the following information on:
   Client neighbors at the client's residence(s),
   Associates at the client's place of employment,
   Client business credit, and/or
   Corporate affiliations for a client business(es).

### Receive and Store Client Data From Third Party Databases (Step 328)

In step 328, at least most of the client information received in response to step 324 (and steps 308 and 322) is stored in a manner that is accessible via a unique identification associated with the client. Note, such client information is preferably stored after being encrypted for security of the information. In particular, a distinct encryption key may be provided for encrypting and decrypting each client's stored information, and such keys may be stored on a separate storage device (and/or data server) so that such keys are only accessible via a secure application programming interface that logs all access to the keys, and allows only a single key to be accessed at a time (with the exception of periodic storage backups). Note that each collection of stored client information (for a given client) contains the client's “baseline data” for one or more identity theft models, wherein the client's baseline data (for one or more models) preferably includes personal information that is not subject to legitimate frequent fluctuations. For example, client FICO scores, and credit balances on a client's credit card(s) preferably are not part of the client's baseline data. However, a client's FICO score range may be sufficiently stable so that such a range may be used as baseline data for some identity theft model. Additionally, identification of a client's credit cards and credit limits therefor may be included in the client's baseline data for one or more models.

In at least some embodiments of the present identity theft detection and mitigation system, the extent of the client's total baseline data may depend on the identity theft areas for which the client has contracted for identity theft detection services. For example, since medical record databases are not generally publicly accessible, the client's information therein may be very difficult to obtain. For example, although in the U.S. each person can by law obtain a copy of his/her medical records from each medical record keeper every 12 months, obtaining such records may be difficult. For example, such records may be received only via a paper request via postal mail or facsimile, and may require presentation of a power of attorney executed by the client. Additionally, it may be similarly difficult to obtain medical insurance payment records on, e.g., a periodic basis from the client's medical insurance provider. Accordingly, such medical theft detection may be an additional service charge to the client. However, in one embodiment, the client's total baseline data (or portions thereof) and client input medical information (or portions thereof) may used as a profile for comparison with profiles of other client's who have been subjected to medical identity theft thereby determining similarities that may be predictive of the client's likelihood of medical identity theft and some indication of the costs associated with identity rehabilitation bearing in mind that for medical records, medical identity theft entries may not ever be deleted. Moreover, note that such comparisons of profiles is not limited to medical identity theft, and thus may be used for predicting, detecting, and/or estimating costs of other types of identity theft. Additionally, in some circumstances it may be possible for the present identity theft detection and mitigation system to assist a client in having the client's medical insurer contact the client prior to: (i) paying any medical expenses identifying the client, wherein such expenses are over a predetermined amount, e.g., 1,000, and/or (ii) changing the client's contact information without notifying the present identity theft detection and mitigation system.

In at least some embodiments of the present identity theft detection and mitigation system, the areas monitored for identity theft detection include at least substantially all areas where identity theft can take place, wherein such areas have corresponding publicly and/or proprietary available data collections that are substantially comprehensive, or wherein such areas have standardized readily accessible client data retrieval services. Thus, the following areas may currently be substantially fully monitored: (1) identity theft for credit fraud, (2) identity theft for client impersonation to gain an illicit advantage, generally at the expense of the client related to the client's professional, educational, criminal (e.g., lack thereof) records. However, it is within the scope and architecture of the present identity theft detection and mitigation system to also provide such services in the area of medical identity theft if and when comprehensive medical data collections become readily accessible by clients and their legal representatives.

### Determine Whether The Client's Total Baseline Data Has Changed (Step 329)

In step 329, a determination is made as to whether there has been a change to a pre-existing value of the client's total baseline data, or, whether at least one value has been obtained (in step 328) for a baseline data field/type that previously had no client value. Note that if the client has no previous baseline data, such as when the client is newly registered for obtaining identity theft services, this determination yields an affirmative result. Moreover, for each baseline data field/type of the client's total baseline data wherein this data field/type has a corresponding (possibly different) value in the most recent client data received from step 328, then a comparison is performed between the total baseline data and most recent client data received for determining if there indeed is a change in the client's baseline data. Note that such a change may legitimately occur due to, e.g., a marriage, change of address, change of insurer, etc. by the client. Additionally, a legitimate change may occur due to a request by the client to have additional or different identity theft models activated that require different baseline data from what was previously associated with the client. However, if the client requests that a reduced set of his/her identity theft models be activated, then even though the client's total baseline data may be different from the newly received client data (e.g., due to less baseline data being required), such a difference will not trigger an affirmative result from step 329 unless at least one value of the newly received client data changes a pre-existing value of the client's total baseline data. Moreover, note that for baseline data of models no longer activated, if such data is not used by another model that is activated, then such baseline data may be discarded or designated as not to be used for detecting identity theft.

### Continue To Use Current Total Baseline Data and Return (Steps 340 and 344)

If the result of step 329 is negative, then step 340 is performed wherein the current total baseline data is left undisturbed and/or is identified as still valid for use in identifying subsequent changes to the client's personal information residing the various public and/or proprietary databases.

Subsequently, step 344 is performed, wherein processing returns to step 208 of the flowchart of FIG. 1, for performing step 212 (and correspondingly steps 304-316 of FIG. 2) again.

Determine Whether The Client Is To Review The Changed and/or New Data Values (Step 330)

Alternatively, if the result from step 329 is positive (thereby indicating that a pre-existing baseline value has changed, or there is a value of a baseline data field/type that previously had no value), then step 330 is performed wherein a determination is made as to whether the client is required to review the changed and/or new data values obtained in step 328. Note that for at least the first performance of step 330 (for the client), this step preferably causes step 332 to be next performed so that the client can confirm, reject, and/or correct his/her personal information. However, beyond this initial performance of step 330, additional performances of step 330 may yield different results depending on the embodiment of the present identity theft detection and mitigation system and method. For example, when it is determined that the client should review the new or different client data, then step 332 and subsequent steps are performed. However, in some circumstances it may be advantageous to determine an identity theft risk assessment prior to the client reviewing the new or different data. For example, the client may request that he/she only be notified if there is a relatively high likelihood of identity theft. In other cases, the client may not timely perform step 332, and accordingly, upon receiving notification that the client has not performed step 332, step 330 may activate the identity theft risk assessment process of step 348 which is described in more detail hereinbelow. In other embodiments, step 330 may determine which of the steps 332 and 348 to activate next depending upon the client identifying particular baseline data fields/types that he/she would always prefer to inspect in the event of a change thereto. For example, the client may wish to be always notified if a particular name variation is received, or any variation of the client's information related to his/her criminal record is detected.

### Client Reviews Newly Obtained Personal Data (Step 332)

In step 332, the client may review his/her total baseline data (if such data is pre-existing), as well as the newly retrieved client data (from the most recent performance of step 328) for identifying errors and/or inconsistencies and/or items of concern. Such a client review may be performed with the assistance of a person trained to assist the client in the review. However, in some embodiments of the present identity theft detection and mitigation system, such client assistance may be at least in part automated so that, e.g., if the client identifies a particular spelling of his/her name as never used, then this particular spelling is automatically flagged in (any) other baseline data records so that the client is not required to repeatedly identify the same misspelling. Moreover, in one embodiment, since the client has already provided at least some personal information in step 304, such information may be used to highlight or otherwise direct the client's attention to data fields with potentially erroneous information such as a field listing the client's social security number with two digits thereof transposed. However, it is preferable that each client have, in at least near real time, access to someone trained in assisting the client in such reviews. In one embodiment, where a client is reviewing his/her total baseline and/or newly collected data via the Internet, the client may request voice communication with such a trained person. For example, an Internet connection to a website associated with an embodiment of the present identity theft detection and mitigation system may be configured so that an audio speaker and an audio receiver at the client's computer may be used to communicate, via VoIP (voice over Internet protocol), with such a trained person by merely selecting (clicking) on a portion of a browser presentation associated with a display of the client's data.

### The Client's Newly Received Personal Data Is Correct (Steps 336-344)

In step 336, a determination is made as to whether the client has identified any incorrect data fields in his/her baseline data. Note that the client may extend the review of his/her total baseline data over more than one review session. Thus, client input to each baseline data review session that occurs, before such a review session in which the client actually submits his/her final input for, e.g., identity theft risk analysis (step 348), is stored and associated with each subsequent review session.

If the client determines that all baseline data is correct, then step 340 is performed, wherein the all baseline data is flagged or otherwise indicated as appropriate for use in identifying subsequent changes to the client's personal information residing the various public and/or proprietary databases.

Subsequently, in step 344 processing returns to step 208 of the flowchart of FIG. 1, for performing step 212 (and corresponding steps 304-316 of FIG. 2) again.

### Perform Identity Theft Risk Analysis and Subsequent Processing (Steps 348-366)

If, in step 336, it is determined that at least a portion of the newly received client data is not correct, then step 348 (included in step 212, FIG. 1) is performed, wherein an identity risk assessment is performed. In a first embodiment, if one or more of the five core client data types: name, current address, birth date, social security number, and phone number have newly received values that are incorrect or suspicious, it is assumed that there is at least some likelihood of identity theft occurring. Accordingly, in one embodiment, step 348 may output the number of incorrect (preferably non-typographical errors) values for these five core characteristics.

More generally, there are at least three strategies for detecting identity theft according to various embodiments of the identity theft method and system disclosed herein (or identity theft detection models therefor). A first strategy corresponds to the first embodiment described in the paragraph immediately above, wherein there is a fixed collection core. That is, there is a fixed collection client data types whose client data values are monitored for changes such that each new value or modified value for one of the client data types in the collection may trigger additional identity theft analysis for determining a likelihood of identity theft occurring. The first embodiment described above is believed to be simple yet effective identity detection model for many straightforward types of identity theft. However, additional models using different fixed collections of client data types are also within the scope of the present disclosure. For example, a model for detecting credit card identity theft may include identification of each new credit card for which the client is financially responsible. Note that in certain circumstances none of the other five client data types may change when a fraudulent credit card is used for which the client may be held responsible.

In a second identity theft strategy, a likely identity theft is detected by triggering further identity theft analysis when the same client data type receives a same improper/incorrect client value deriving from two independent events ascribed as being initiated by the client. For example, an incorrect client email address may be detected for receiving client bank statements electronically, causing a slight elevation in the likelihood of identity theft, and subsequently, the same incorrect email address may appear for receiving credit card statements from a particular department store. The likelihood of the same email incorrect email address being to two different independent entities may be indicative of identity theft. Particularly, when one bears in mind that a substantial percentage of identity thefts are perpetrated by relatives and/or those living with the client that may have access to virtually all of the client's personal information.

In a third identity theft strategy, a likely identity theft is detected when a once legitimate client value that is no longer legitimate is detected as being used on the client's behalf.

In a further identity theft strategy, a likely identity theft is detected when a sequence of events is detected. For example, a wealthy client may have one or more employees with access to his/her personal information, and the client may be too busy to fully monitor all activities conducted on his/her behalf. Accordingly, a sequence of events may be detected for which the client should be notified regarding a possible identity theft. For example, as one of the client's employees may have declared bankruptcy, and within three months of detecting the bankruptcy, it is also detected that the client's charges for certain drugs are from a different pharmacy, and the charges are higher than a predetermined threshold. It is possible that none of these three events by themselves would be cause for concern, the detection of the combination may lead the present identity theft method and system to trigger additional analysis and/or notify the client.

Each of the above three strategies for identity theft detection are within the scope of the present disclosure. Moreover, these strategies may be combined to offer a more comprehensive solution for detecting identity theft.

Returning now to step 348, in a second embodiment thereof, one or more identity theft models may be used for detecting identity theft, wherein such models have a standardized interface so that each model may be selected or deselected depending on the type and the extent of identity theft which is to be detected. Thus, an identity theft assessment engine or module activates each of the selected models for, e.g., determining whether there are sufficient discrepancies between the client's baseline data (for the model), and the most recently received client data (step 328) to indicate some non-trivial likelihood of identity theft. In this second embodiment of step 348, risk assessment may be performed according to the description and pseudo code of Appendix A hereinbelow, wherein “importance values” are computed that are believed to more indicative of identity theft as such values increase in value. The identity theft assessment engine may perform the following high level steps of identity theft analysis when provided with input for each of the identity theft models to be used in detecting identity theft:
(A) Determine the core data types that are important to the model.
(B) Determine the legitimate client values for these core client data types (referred to as “core values” hereinbelow).
(C) Compare the core values with the client data items received from the most recent activation of step 328 for determining the collection of (any) client data items from the most recent activation of step 328 that are “suspicious data items”; i.e., such client data items that have at least one value for one of the core data types that is not known to be legitimate. Note, this corresponds to the first identity theft strategy described above.
(D) Determine if any of these suspicious data items has a value (referred to as a “suspicious value” hereinbelow) for a core data type, wherein the suspicious value is:
   (i) not known to be legitimate for the core data type,
   (ii) has occurred previously in a client data item, and
   (iii) the new instance of this suspicious value and the previous instance of this suspicious value are not the result of a common or single act by the client and/or an imposter.
   If such determination is positive, there is an increased likelihood of identity theft related to the suspicious value. Note, this step corresponds to the second identity theft strategy described above.
(E) For each of the suspicious data items that do not have a suspicious value that has occurred previously, perform the following steps:
   (i) Retrieve all past client data items (relevant to the model) that have a timestamp indicative of a client and/or imposter action occurring in a window of time of, e.g., predetermined length.
   (ii) Determine if there are one or more values (V) for a core data type for the suspicious data item wherein:
      (a) The suspicious data item includes data that was previously correct for the client, but is no longer correct. In particular, there is a timestamp for the suspicious data item that is indicative of a time of an occurrence of an action by the client or an imposter resulting in the suspicious data item, and wherein this timestamp is in a time frame that prohibits V from being legitimate for the client (for example, the suspicious data item may be a record indicative of a recent request for a new credit card in the client's name, wherein V is a previous address for the client that is not applicable to the client at the time the request for the new credit card was made), and
      (b) There is a different client data item in the most recent activation of step 328 or the past data items determined in (E)(i) above wherein:
         (1) V (or a typographical variation thereof) occurs in the different client data item;
         (2) the suspicious and the different client data items are not the result of a common or single act by the client and/or an imposter,
         (3) the different data item has a timestamp for that also is in a time frame that prohibits V from being legitimate for the client (for example, the different data item may be a record indicative of a request for a new driver's license in the client's name, wherein V is the same previous address that is no longer applicable to the client).
   If these conditions occur, then increase a likelihood that an identity theft is occurring. Note, this step E corresponds to the third identity theft strategy described above.
(F) Return the sum all the importances determined as a measurement of the likelihood of an identity theft occurring.

An embodiment of the steps immediately above described in more detail in the pseudo-code of Appendix A.

Subsequently, in step 352, a determination is made as to the likelihood of an identity theft occurring. Such a likelihood can be measured via a predetermined scale, e.g., 0 to 10 with 10 being the highest likelihood of identity theft. However, for simplicity in the description following, only three identity theft risk measurements are shown, i.e., (i) no identity theft detected, (ii) a low (but not trivial) likelihood of identity theft is detected, and (iii) a high likelihood of identity theft. If the first embodiment of step 348 (described hereinabove) is performed, then for a corresponding embodiment of the present step 352, if the most recently received client data (step 328) includes no client value for the five core characteristics that is incorrect or not previously known to be correct, then it is believed that no identity theft is occurring. If the client data received from the most recent performance of step 328 has only one of the five core characteristics that is incorrect or not previously known to be correct, then it is believed that the likelihood of identity theft is low, particularly if the change to the client's personal data is determined to likely be a typographical error. However, if more than one of these core characteristics have a newly received value that is: (i) incorrect (and not clearly a typographical error), or (ii) not previously known to be correct (and not clearly a typographical error), then it is assumed that there is a high likelihood of identity theft. Accordingly, each of the core characteristics is given equal weight (i.e., a multiplicative weighting of one) in evaluating the likelihood of an identity theft taking place. However, it is within the scope of the present disclosure that such core characteristics may be weighted differently, e.g., depending on the type of identity theft being detected. In particular, each such weight may reflect an effectiveness of the corresponding core characteristic in predicting (a particular type of) identity theft. For example, for a particular type of identity theft (in, e.g., a particular locale such as a particular metropolitan area), changes to core characteristics (and/or time lines for such changes) may be statistically evaluated using, e.g., linear programming or statistic regression techniques to generate the weights for each of the (non-typographical) changes to the core characteristics so that identity theft likelihoods more accurately reflect the identity thefts that have occurred (e.g., in the last one to two years, although longer or shorter time periods may be used). Additionally, note that other techniques for generating such weights are within the scope of the present disclosure, including artificial neural networks, etc. Thus, as one of skill in the art will understand, such weights may be determined by analysis of previous identity thefts that have taken place. For instance, for a particular type of identity theft, a time line of identity theft related events may indicate that an address change is most likely to occur first followed by a new driver's license issued to the client. Accordingly, assuming that in addition to the core characteristics above, there is a core characteristic for the client's driver's license, then the weightings for a change in the address core characteristic, and a change in the driver's license core characteristic may be provided with the highest weightings followed by lower weightings for the other core characteristics. Moreover, since step 362 described hereinbelow contemplates retrieving detailed and potentially extensive information additional client related information, such weights may be used to determine or select what types of additional client related information to retrieve, or from where such additional client related information is to be retrieved. For example, suppose that the following rule is known and used by an embodiment of the present identity theft detection and mitigation system:
If a client's assets exceed four million dollars, and the client lives in California, and if within the last month, there has been both an address change for the client and a new driver's license issued to the client in California, then an identity theft is likely to occur for purchasing at least five items, each item having a value of at least $2,000 within two weeks of the new driver's license issuing.
   Accordingly, additional client information may be selected for retrieval so that the additionally retrieved client information is directed more to the client's financial records than other types of client information (e.g., medical records, property records, criminal records, etc.). Moreover, various credit providing institutions may be notified of the likeliness of the client's identity being stolen.

Alternatively, if the second embodiment of step 348 described above is performed, then in step 252, if the identity theft importance measurement (for each of the models selected for activation) returns a value, wherein the higher this value, the more likely a theft of the client's identity is occurring. For example, in the more detailed embodiment described in Appendix A following, an importance value between 0 and ½, such a model may be said to have detected no identity theft, any such model returning an importance value greater than or equal to ½ and less than 1 may be said to have identified a low likelihood of identity theft, and any model returning an importance value greater than or equal to one may be said to have identified a high likelihood of identity theft. Of course, an alternative measurement of a likelihood of identity theft could be chosen so that instead of such measurements monotonically increasing with a likelihood of identity theft, such measurements could monotonically decrease with a likelihood of identity theft.

Note that in one embodiment of step 352, this step may modify the frequency with which step 324 is performed to obtain additional instances of client data from the plurality of public and/or private databases. In particular, as the likelihood of identity theft increases (decreases), the frequency with which steps 324, 328 and subsequent steps are performed increases (decreases). For example, the frequency with which step 324 is performed may increase from once a month to twice a week or even daily when there is a very high likelihood of identity theft occurring. Conversely, the frequency may be lengthened when no identity theft is detected for an extended period of time, e.g., six months. However, it is preferred that that elapsed time between performances of step 324 is no longer than one month.

In step 354, the client is notified of the identity theft likelihood results, e.g., via email and/or phone. Such results may provide: (i) a description of the type(s) of identity theft detected, (ii) a measurement of a likelihood that identity theft is occurring, (iii) preventative/corrective measures that can taken by the client, and/or (iv) preventative/corrective measures that can taken by the present identity theft detection and mitigation system and method. In one embodiment, the present system and method may be configured (preferably by the client) to let the client subsequently specify what (if any) further processing he/she wishes to be performed. Note that the client has previously specified one or more identity theft configuration settings for handling low danger identity theft responses. For example, the client may specify that all low danger (likelihood) identity thefts be ignored.

However, in the embodiment of FIG. 2B, in the event that a low identity theft likelihood is determined, step 358 is performed wherein a determination is made as to whether further processing is to be performed for further determining whether an identity theft may be actually occurring. This step may include performing one or more of the following actions:
(i) Receiving instructions from the client for specifying how to proceed; and/or
(ii) Performing certain tasks by the identity theft detection and mitigation system and method for automatically determining how to proceed. For example, if the client's identity theft assessment persistently is “low likelihood”, then after a predetermined number of such consecutive assessments, step 358 may reduce the frequency that step 362 (described hereinbelow) is performed. More specifically, if after a succession of “Low Likelihood” assessments (over, e.g., a period of two months or more) where step 362 was performed each time, step 358 may be changed so that it activates step 362 only, e.g., every other time in a continuing series of “Low Likelihood” assessments. However, once such a series is broken by a “High Likelihood” assessment, step 358 reverts back to a default of more frequent activation of step 362.

If it is determined (in step 358) that additional identity theft analysis is to be performed, then steps 362 and 364 are performed, wherein the comprehensive retrieval service/subsystem is activated for obtaining additional client information (e.g., detailed client records related to the type(s) of identity theft suspected to be occurring), and for performing additional identity theft analysis resulting a more definitive conclusion as to whether an identity theft is occurring. Note that obtaining such additional client information, and such additional analysis may be performed by a person trained in reviewing client records for determining identity theft. For example, for a suspected theft or illegitimate use of a client's professional identity, various related professional organizations may be queried for determining improper client membership records (and/or duplicate client membership). Moreover, the person trained in reviewing such client records need not solely rely on his/her training and experience, since an embodiment of the present identity theft detection and mitigation system and method may include stored (or derived) sequences of tasks for identifying and analyzing client data that is specific to the suspected (type of) identity theft. Moreover, such sequences may be pre-stored in a database. Alternatively/additionally, such sequences may be generated dynamically by a programmatic system (e.g., an expert system, or another system for generating identity theft related interferences and/or hypotheses) as the trained person interacts with the system, wherein the system makes decisions and/or forms hypotheses according input received from the trained person.

Alternatively/additionally, various automated tools may be used to analyze the additional data. For example, automated tools may be provided for identifying and contacting various merchants whose identities occur on a client's credit card statement and for which the client does not recognize making a purchase from the merchant. Note, such tools may be particularly useful for purchases that occur on the Internet wherein each purchase is conducted by a transaction clearinghouse responsible for completing transactions for a large plurality of Internet merchants. Additionally, such tools may present the client with a list of the most likely ways (as determined from previous actual identity thefts) that the potential or currently occurring identity theft is likely to have occurred, and corresponding strategies for correcting such thefts. For example, such automated tools may be interactive with the client or a person trained in identity theft data analysis, wherein such a tool generates hypotheses and/or inferences as to the next likely identity theft related event(s) the client may expect to be performed by an imposter, and a prioritization of tasks for the client to perform to combat events and/or to identify the imposter. Note that quick identification of an imposter may be particularly important when the imposter is likely to be a relative, a caretaker for the client, or another person having ongoing intimate knowledge of the client's personal information, or an acquaintance of one of these formerly listed persons.

Accordingly, in step 364, a determination is made as to whether the client's identity is being stolen, and the type of identity theft that is likely occurring. Note that after a detailed review of the client's personal data, it may be that no identity theft has actually occurred, and identity theft processing returns to step 324 which will be performed after a predetermined elapsed time of, e.g., 1 day to 1 month or longer. Moreover, when no identity theft is detected, the processing performed in step 364 may also include configuring, annotating and/or reducing the importance of client values/records received in step 328 that resulted in the activation of the comprehensive retrieval service/subsystem (i.e., steps 362 and 364). Accordingly, when the same erroneous or problematic client data is obtained again in step 328 (e.g., within a predetermined time period, such as, a year) without additional information for suspecting identity theft, the present identity theft detection and mitigation system and method will not alert the client in the same way, and not request additional detailed identity theft analysis to be performed. At least in the case where identity theft is finally identified as highly likely to be occurring, the client may be notified (if not previously notified) by various techniques including automated phone calls (e.g., to home, work and cell phone numbers), automatically generated emails, text messages, instant messaging, as well as through postal mail to the client and/or client designated contact persons. Note that certain security features are provided on such communications so that such communications are not readily communicated to someone other than the client. Accordingly, such communication may merely indicate that the client is to contact the identity theft detection and mitigation system for obtaining a notification, wherein the client can be verified as in step 308 described hereinabove.

In the embodiment shown in FIGS. 2A,B, if the identity theft assessment output by step 352 indicates that there is a high likelihood of identity theft, then step 354 is also performed for notifying the client, and subsequently, steps 362 and 364 are immediately performed.

In some embodiments of the identity theft detection and mitigation system and method, a client may be able to configure the system and method, e.g., via selection/deselection of certain rules or conditions that can be used to determine what further identity theft processing should be automatically performed. For example, the client may pre-select rules such as the following for activation:
(i) If, upon detection of a high likelihood of identity theft occurring, where there is no response from the client within a predetermined time period (e.g., 3 days), then automatically initiate further identity theft processing for further determining whether an identity theft is likely to be in process (e.g., activate the comprehensive retrieval service/subsystem for performing further analysis, and possibly initiating identity rehabilitation by activating the identity rehabilitation service/subsystem).
(ii) If, upon detection of a high likelihood of identity theft occurring, there is no response from the client within a predetermined time period (e.g., 2 days), then contact the client via phone.
(iii) If, upon detection of a high likelihood of identity theft occurring, there is no response from the client within a predetermined time period (e.g., 2 days), then contact a person designated by the client.
(iv) If, upon detection of a low likelihood of identity theft occurring, there is no response from the client within a predetermined time period (e.g., 1 week), then contact the client via phone.
(v) If, upon detection of a high or low likelihood of identity theft occurring, there is no response from the client within a predetermined time period (e.g., 1 month), and an attempt to contact the client via email and phone have not succeeded, and (any) predetermined client specified other contact has not responded, then automatically initiate further identity theft processing for further determining whether an identity theft is likely to be in process (e.g., activate the comprehensive retrieval service/subsystem for performing further analysis, and possibly initiating identity rehabilitation by activating the identity rehabilitation service/subsystem).

Accordingly, if, e.g., one or more of the rules (i) or (iv) have been selected by the client for activation, then if the antecedent “if” portion of such a rule is satisfied (e.g., evaluates to TRUE), then step 362 is performed without further client input needed. Note, that step 362 may activate the comprehensive retrieval service/subsystem, and this subsystem may perform step 364 for determining with greater certainty whether an identity theft is in progress.

Subsequently, if it is determined in step 364 that an identity theft is occurring, then step 366 is performed, wherein the identity rehabilitation service/subsystem is activated.

The foregoing discussion of the invention has been presented for purposes of illustration and description. Further, the description is not intended to limit the invention to the form disclosed herein. Consequently, variation and modification commiserate with the above teachings, within the skill and knowledge of the relevant art, are within the scope of the present invention. The embodiment described hereinabove is further intended to explain the best mode presently known of practicing the invention and to enable others skilled in the art to utilize the invention as such, or in other embodiments, and with the various modifications required by their particular application or uses of the invention.

### Appendix A

Risk Assessment (Step 348): The following description provides an embodiment of the data structures and processes for assessing identity theft risk, wherein there may be multiple identity theft risk assessment models for assessing the same type of identity theft and/or different types of identity theft. The following data and processing features are important to keep in mind when reviewing the pseudo code hereinbelow.
   1. Client fields, more generally client data types (also known as client types, client attributes or client characteristics). Such fields/types include client personal information used in detecting and/or identifying identity theft. These client types may have multiple client values associated therewith. For example, a name field/type may have a number of variations of a client's name(s) as values, wherein each such variation must be assessed for determining a likelihood of one or more such names being implicated in a theft of the client's identity.
   2. Weightings for client fields/types & values therefor. Each client field/type and/or a value(s) therefor may have one or more weightings, wherein each weighting is indicative of the field's (value's) importance in predicting at least one type of and/or occurrence of identity theft. E.g., such a weighting for a client's current address field/type may be less than a previous address filed if the client just moved. Such weightings can be determined from modeling actual occurrences of various types of identity theft. Moreover, there may be weightings for client fields/types and/or values therefor that are specific to a particular computational model of identity theft, and the model may change such weightings over time (e.g., depending on how effective the fields and/or values are at predicting an actual identity theft), as well as change its assessment as to whether a particular type of identity theft is likely. For example, in a model for detecting impersonation of a client's professional, or educational background, determination of all places where the client is presumably employed may be an important indicator of identity theft. However, for other types of identity theft, such employment information may not be exceedingly important. Thus, the present system/service provides substantial flexibility to appropriately adapt with changing business strategies and/or directions regarding identity theft. For example, it is believed likely that newly discovered identity theft techniques are likely to have substantially distinct steps or sequences of steps that can be detected from the data items collected for the client. Such distinct steps or sequences thereof may be viewed as a fingerprint or signature of a corresponding type of identity theft for which a corresponding model may be used for detection.
   3. Such modeling may include actual computational models that can adapt with new input, e.g., from the client and/or various data sources.
   4. For at least some (if not most) identity theft computational models, each such model has one or more (generally, a plurality of) core or baseline client data types associated therewith, wherein such baseline client data types are the data structures for client personal data that is particularly important for the model to detect and/or identify a theft of the client's identity. In particular, such baseline or core client data types (and/or the values therefor):
      (i) Are generally persistent; i.e., the values for such baseline client data types do not change frequently (generally, such values are valid for at least 2 years, and likely 5 years or more); and
      (ii) Are the most predictive in providing the corresponding model with the ability to accurately detect identity theft; e.g., a change to values of such baseline client data types is more likely indicative of a type of identity theft detected by the model than values for the model's non-baseline client data types. In at least some identity theft models, their corresponding baseline client data types include at least the following fields: client name, client current/previous address, client date of birth, client social security number, client phone number(s) (more generally, contact information, including email address(es)), and client driver license(s). However in some kinds of identity theft (e.g., medical identity theft), such core or baseline fields may include medical, and/or dental insurance information, and additionally, medical/dental history for the client, etc. Moreover, in other types of identity theft (e.g., professional credential theft) there may be additional/alternative core client data types that are very important in predicting identity theft, such as, core client data types for client professional registration information (e.g., for doctors, lawyers, engineers, nurses, morticians, etc.).
   5. Each value in each baseline client data type may have “applicability data” indicating, e.g., what the time range is for the value to be applicable to the client. In most cases, such applicability data may include at least a beginning date. However, in some cases, e.g., for a previous client address, there may be also an ending date. Note that such applicability data may include non-date information as well, e.g., if it is known that a client uses first name, middle initial, and last name on all of his/her records except one medical related client account wherein he/she uses only first and middle initials with last name on this account, then the applicability data for a name such as “I. B. Smith” may also include information identifying that this version of the client's name is only for medical related client records. Accordingly, if such a name shows up on a driver's license, then this may be very indicative of an identity theft.
   6. The core or baseline fields may be determined on a client by client basis, e.g., depending on what services the client contracts for. This provides more flexibility for the present system and method to meet changing business strategies and/or directions. For example, a client may initially only contract for identity theft services related to credit/debit cards, bank accounts, etc. However, the client may eventually wish to expand such identity theft protection to include detecting identity theft related to his/her legal records.
   7. It is assumed, in at least one embodiment, that once a model's collection of core/baseline fields are populated for a client, then such information is not only accurate, but also complete (i.e., there is no legitimate client values that are not identified in the field). Of course, this assumption may be incorrect, and such incompleteness is effectively handled by, e.g., presenting such legitimate (but previously unknown) client values to the client for verification.
   8. It is assumed that each client data item retrieved from (third party) data sources has at least two dates associated therewith: (1) a date that the corresponding event being reported occurred, and (2) the date the data item is retrieved. It is assumed that substantially every client data item has additionally an identification of a source that associated the data item with the client.
   9. The frequency of analysis for identity theft may be dependent on the outcome of at least the previous assessment of identity theft. So, e.g., if the previous identity theft assessment is very high, then the period of time between retrieving new data items from (third party) data sources is decreased. Correspondingly, if the assessment goes down, then this period of time between data retrievals may increase.
   10. It is assumed that once data items are retrieved from (third party) data sources for a client, that such data items are filtered to remove data items that are duplicate records of the same event. Note, such filtering may be performed by the date (and possibly time) of the event together with an identification of the event.
   11. There may be one or more assessments for a likeliness of, or susceptibility to, identity theft that is different from an analysis for any particular type of identity theft being in progress. One such assessment may be “global” assessment as well as particular assessments (e.g., likeliness of or susceptibility to medical identity theft). The weightings obtained from such assessments may be used in assessing the likelihood of any particular scenario being indicative of identity theft. Note, it appears that in at least some cases of inconsistent data it may be difficult to clearly determine whether one or more inconsistencies are just “noise” in the data or indicative of an actual identity theft, and such global assessments may favor one conclusion over another.
   12. For each identity theft model, inconsistencies between newly retrieved client data from (e.g., from third party) data sources, and a client's core/baseline information (for the model) are analyzed to determine whether the inconsistency is due to a typographical error (e.g., noise in the data), or due to client forgetting to identity the inconsistency, or due to some of the information being legitimate for another person (other than the client), or due to identity theft. It is assumed that such an inconsistency is more likely due to an identity theft when a similar inconsistency occurs in more than one of the client's data items (that are directed to different events). E.g., an inconsistency due to an unrecognized variation in the client's name in a current data item representing a new credit card application may be more indicative of identity theft when the same name variation is also found on a data item representing a collection agency entry (for an unpaid debt) that occurred in some recent time period.
   13. The client is notified of all changes in the core/baseline fields, and with such notification additionally the client may be given: (i) an assessment or likelihood that an identity theft is being attempted or in progress, (ii) the reasoning behind the assessment (e.g., two data items (for two different events) have the same unrecognized value in a core field), (iii) given advice on what steps to take (or are being taken by the system; the system may automatically commence identity rehabilitation in certain circumstances specified by the client), and/or (iv) may be given an assessment or likelihood of the client being a potential target of identity theft.
   14. An identity theft assessment model may have the following computational methods associated therewith:
      (a) an identification method for identifying two or more data items obtained for the client as the same data item as far as the MODEL is concerned;
      (b) a comparison method for identifying “comparable” data items, i.e., the model includes information identifying which client data items (and which fields thereof) contain information that can be compared for detecting identity theft; for example, corresponding fields for comparable data items may be compared for detecting changes that may be indicative of identity theft according to the model; e.g., versions of a client's driving record for a particular state at two different times, or a client's educational record at two different times, etc.; in most cases it should be the case that for comparable data items, each such data item has the substantially the same set of client identity characteristics (e.g., fields), assuming that the different versions of comparable data items come from the same data source; however, comparable data items may come from different sources, e.g., two different credit reporting sources, and accordingly, may not have entirely identical client characteristics;
      (c) a core characteristics method for determining the “Core_client_data_characteristic_Types” (as used in the pseudo-code hereinbelow); i.e., the types of client identity characteristics) important to the model (and considered by the model) as described hereinbelow;
      (d) a relevant data item type method for determining the types of data items (each type also known “client characteristic type” hereinbelow) that are at least relevant to the model; i.e., not ignored by the model in determining a likelihood of identity theft, e.g., for a medical identity theft model, a relevant data item type method may be one that can be used to select or identify data items known to be related to insurance bills submitted to the client's insurance company; for a model that detects credit identity theft, a relevant data item method may be one that can be used to select or identify data items known to be related to new credit card applications obtained in the client's name.
      (e) a data item type importance method for associating with a data item type, a ranking indicative of an importance of the type to the model; e.g., a model for medical identity theft may associate a highest ranking to a data item indicative of a surgical procedure request for authorization or payment, while a criminal record identity theft model may instead associate a highest ranking to a charge for burglary identified with the client; note that in both of the medical or the criminal identity theft models, a data item for a magazine subscription by the client may be ranked low, or even transparent to the model.
      (f) a relevant values for characteristics method for determining client characteristic values that are at least relevant by the model; i.e., not ignored by the model in determining a likelihood of identity theft;
      (g) an data item independence method for determining the data items that are deemed to be “independent” of one another, i.e., a data item d is independent of data item d₁ exactly when at least one of the data items is assumed (according to the model) to require a different and unique purposeful act by an entity (e.g., an imposter or the client or by some other person acting on behalf of the client) to produce the data item, wherein the act NOT required to produce the other data item. For various models, examples of d and d₁ may be: (i) two data items for a client's MEDICAID record with an entirely different addresses (not a typographical error), (ii) two data items for a client's legal name wherein the client's name is significantly different in the data items (e.g., not a typographical error of one another), (iii) data item identifying a new credit card application and a data item for registering a horse for a horse race. Note that an example of two non-independent data items (depending on the model) might be a data item indicative of an overdue credit card account, and a data item indicating that this same credit card account was turned over to a collection agency since it may be assumed that no action by an imposter, the client or another on behalf of the client was required to cause the generation of the data item indicating that the credit card account was turned over to the collection agency. Thus, the data item independence method can be used to determine whether one of two client related data items is assumed (by the model) to be merely a consequence of the other data item, and not a reflection of independent events that changes a client's personal information;
      (h) a typographical error method for designating that the differences between two values for a same data field are assumed to NOT be a purposeful act by an entity (e.g., an imposter) to produce the differences;
      (i) for each identity theft model (“MODEL”, in the pseudo-code hereinbelow), there may be a model specific collection of (zero or more) paired lists (V_List, DI_List), wherein
         V_List is a list of pairs (V, CCT) where CCT identifies some client characteristic type for MODEL, and V is a value for CCT that has been previously determined to be “suspicious” for detecting/identifying a theft of the client's identity. Note, however, that V may or may not be legitimate for the client, and
         DI_List is a list of one or more client data items/records, i.e., client related personal data records, each corresponding to a client or imposter initiated event, wherein:
            (i) each of these client data items/records (rec) on DI_List was obtained in some activation of step 328 prior to the most recent activation of step 328,
            (ii) for each (V, CCT) pair on V_List, V is a value of CCT from member (rec) of DI_List.
            (iii) the data items on DI_List have also been previously determined to be suspicious for indicating identity theft by MODEL (in a previous activation of step 348) due to the collection of values V in members of V_List.
         It is believed that for most identity theft models, a single pair (V_List, DI_List) suffices, wherein such a pair effectively identifies all triples of:
            a suspicious value,
            a client characteristic type having the suspicious value, and
            a client data record, e.g., retrieved from a third party data source.
         Moreover, as one skilled in the art will recognize, there are alternative data structures for capturing and providing access to the above-identified triple.
            Thus, the pairs on V_List may be indicative of identity theft, and should be reviewed together (e.g., compared) with values from newly obtained client data items obtained from the most recent activation of step 328. Moreover, each V_List has an “importance” measurement associated therewith, wherein the importance measurement is indicative of how important V_List is in detecting an identity theft according to the identity theft model, MODEL. Such a collection of the paired lists (V_List, DI_List) and the corresponding “importance” of each V_List is referred to as a “Watch_List” hereinbelow.
      (j) one or more time windows, each time window identifies a window in time extending from the present to some point in the past; each time window has associated therewith a client characteristic type (e.g., client current address, name, employer, etc.), and the associated time window is for selecting potentially temporally important client related data items (for detecting identity theft) having a retrieval times (form the various data sources) that are in the time window. For example, a time window for a current address client characteristic may be 6 months. So data items in this time window can be all data items (and/or groups thereof as in (h) above) having the current address client characteristic specified therein, and wherein these data items (or groups thereof) have been collected in the past 6 months. A time window for a client's name characteristic may be, e.g., five years (e.g., for identifying suspicious variations being used over time).

```
ID_Theft_Risk_Assessment
/* Returns a “Total_importance” array having values indicative of a likelihood of identity theft
  occurring, one value for each identity theft model activated (selected by the client), wherein for each
  value, when it is:
      between 0 and ½, no identity theft is detected;
      greater than or equal to ½ and less than 1, a LOW DANGER of identity theft is detected;
      greater than or equal to one, a HIGH DANGER of identity theft is detected. */
{
  For each MODEL[k] selected for assessing ID theft, k = 1, 2, ..., number of models selected do
  {
Core_client_data_characteristic_Types ← A set of client data characteristic types related to the
        client's identity according to MODEL[k]; this may include data types for one
        or more of the following kinds of client data: (i) the client's name (and
        variations thereof used), (ii) client current address, (iii) client date of birth
        (possibly location of birth as well), (iii) client contact information (phone
        number, email, etc.), (iv) client drivers license(s), and (v) depending on
        information supplied by the client and/or from what type(s) of identity theft
        the present model detects, one or more of: client professional registration
        identifications (e.g., doctor, lawyer, nurse, dentist registrations), various
        client licenses (e.g., pilot license, fishing/hunting license, license for carrying
        a weapon, real estate license, etc.), client medical identifications (e.g., client
        Medicare, Medicaid, medical insurance identifications), client educational
        information (e.g., degrees obtained, educational institutions attended, etc.),
        client criminal record (or lack thereof), financial instruments for which the
        client is responsible (e.g., credit/debit cards, checking accounts, personal
        liabilities from leases and/or co-signatures executed, etc.), client personal or
        professional or business relationship information (e.g., identification of
        relatives, friends, individuals having easy access to the client's personal
        information, etc.), as well as other types of client personal information.
Legitimate_Core_Values ← A collection of data triples, each data triple being (V, CCT, AD),
        where
            V is a confirmed/legitimate client value for one of the client data
            characteristic types (CCT) of the client (e.g., current address, fishing
            license number, medical insurance identification, mother's maiden
            name, etc.), and
            AD is applicability data defining one or more time ranges in which V
            is a confirmed legitimate client value for its corresponding data
            characteristic type CCT, e.g., AD is a range of dates that V is
            applicable to the client;
        Note for a particular date PD, the triple (V, CCT, PD) will be referred to as
        “subsumed” by a triple (V, CCT, AD) exactly when PD is contained in the
        time range for AD. Additionally, note that for each of the client data
        characteristic types in Core_client_data_characteristic_Types, there is
        assumed to be at least one member of Legitimate_Core_Values for each
        instance of MODEL[k].
IdTheft_Likelihood_Global_MODEL_Assessmt ← 0; /* Assume there is no likelihood of
                                    identity theft initially for this MODEL[k] */
D₀ ← Obtain the new versions of the client's data items/records received from the most recent
        activation of step 328; individual data items of D₀ are denoted D₀[i] hereinbelow; /*
        Note, for each member D₀[i] of D₀, D₀[i] includes: one of the client's personal data
        items/records retrieved from, e.g., third party data sources, the date of an event
        (initiated by the client or imposter) from which client personal information in D₀[i]
        was obtained, the date of retrieval, and the source of the information retrieved. */
Notif ← Create and store a Client Notification object for notifying the client of (any) identity
        theft threats to be detected, wherein this object includes: for each data item D₀[i]: (i) a
        field “IdTheft_Likelihood[i]” for storing a value indicative of a likelihood of an
        identity theft in progress, (ii) the date D₀[i] was obtained, (iii) a pointer to D₀[i], (iv) a
        descriptor or code indicating the reason and evidence for the (any) suspected in
        progress identity theft, and (v) a record of when the notification is to be provided to
        the client and how it got transmitted to the client;
D ← Get the data items/records in D₀ that: (i) have a data item type that is relevant to the
    MODEL[k] as determined by the MODEL[k]'s relevant data item type method, and (ii)
    have at least one value (V₀) for at least one of MODEL[k]'s
    Core_client_data_characteristic_Types (CCT₀), wherein V₀ is NOT included the
    corresponding Legitimate_Core_Values for CCT₀; i.e., the data items of D are at least
    somewhat suspicious for detecting theft of the client's identity;
/* Note, each member D[i] of D is viewed as a possible indication of ID theft since each D[i] is
  relevant to MODEL[k], and has at least one value for one of types in
  Core_client_data_characteristic_Types, wherein the value is not in Legitimate_Core_Values
  for MODEL[k], or is not applicable to the client at the time indicated by (e.g., timestamp for)
  D[i]. */
If (there is a client related rule for notifying the client when D is non-empty) then
    Prepare the notification object, Notif, for outputting to the client with the members of D;
Watch_List ← Get the Watch_List for MODEL; /* See the discussion at 14(i) above regarding
  “Watch_List”. */
For each member (WL) of Watch_List, do /* WL includes at least one (V_List, DI_List) pair
                    (VL_{WL}, DI_{WL}) plus an “importance” for VL_{M} */
  VL_{WL}.old_importance ← VL_{WL}.importance; /* save the previous importances that indicative
  of a likelihood of identity theft; */
/* Determine if any of the values of members of D have been seen before and derive from a
different client or imposter initiated event. */
For each data item or record D[i] of D do
{
  Watch_List_Candidates ← NULL;  // initialization
  Found ← FALSE; /* D[i] values for Core_client_data_characteristic_Types not yet
    found to be suspicious (i.e., on Watch_List) */
  For each member (WL) of Watch_List do /* WL includes a (V_List, DI_List) pair (VL_{WL},
    DI_{WL}) plus an “importance” for VL_{WL} */
    If (((at least one portion of the client's personal information in D[i] is also identified as
      one of the types in the Core_client_data_characteristic_Types for MODEL[k]) AND
      (this at least one portion is also a V coordinate of a member of VL_{WL} of WL) OR
      (D[i] = D[j] for some other member of D wherein D[i] and D[j] are independent
      according to MODEL[k]'s data item independence method) then
    {
        Found ← TRUE;  /* a new occurrence of a suspicious client type has been
                            found */
        If (the DI_List DI_{WL} of WL includes at least one client data item/record (DI_{WL})
            that is determined by MODEL[k]'s data item independence method to be
            independent of D[i]) then
        {  /* the new occurrence is likely unrelated, so update an importance of this for
              detecting ID theft, and update the recent date that it is detected */
            /* Increase the importance of VL_{WL}*/
            VL_{WL}.importance ← VL_{WL}.importance + 1;
            /* update last date detected */
            VL_{WL}.recent_date ← current date;
        }
    }
    If ((FOUND is TRUE) AND (there is a client related rule for notifying the client when a
        duplicate occurrence of a suspicious client type has been found)) then
      Prepare the notification object, Notif, for outputting D[i] to the client with its
      duplicate previously stored;
    If (NOT Found) then /* No portion of D[i] was identified as being another occurrence
      of a “suspicious” value for one of the Core_client_data_characteristic_Types for
      MODEL[k] */
      Put D[i] on Watch_List_Candidates;
/* Need to determine the importance of members of Watch_List_Candidates; these data items
  have not been previously detected (at least as far as Watch_List is concerned). */
For each DI of Watch_List_Candidates do
{
  DI.importance ← 0;  // initialization
  If (some of the Core_client_data_characteristic_Types for MODEL[k] have an ordering or a
    partial ordering according a particular ordering of events indicative of a particular type of
    identity theft) then
  {
    Type_orderings ← get each (if any) maximum length ordering and maximum length
      partial ordering for the client data characteristic type changes indicative of a
      sequence of client identity theft events being modeled by MODEL[k];
    Chain_length ← Length of max chains in Type_ordering; /* It is not assumed that all
      ordered chains in Type_ordering are of the same length. */
  }
  Else Type_ordering← NULL;
  For each CCT of the Core_client_data_characteristic_Types for MODEL[k] do
  {
    Past_Client_Data_Items ← all client data items obtained in MODEL[k]'s time window
                            for CCT prior to the most recently obtained data items;
    For each CCT value (VI_{DI}) of DI, wherein the triple (VI_{DI}, CCT, original generation date
      of VI_{DI}) is not subsumed by one of the triples of Legitimate_Core_Values do
      For each DJ in Watch_List_Candidates plus Past_Client_Data_Items, wherein DJ is
        not DI, AND DJ is independent of DI according to MODEL[k]'s data item
        independence method do
        If (Type_orderings is not NULL) then
          If (using the values of DJ, all other types in the ordering prior to the change to
            VI_{DI} in CCT of DI have been changed in a manner wherein the values these
            other types are related for indicating the type of identity theft being
            modeled by one of the chains identified in Type_orderings)
            then // the identity theft being modeled may be in progress
          { /* So increase the importance of DI according to some function of the
            Core_client_data_characteristic_Types for MODEL[k] */
            CCT_weighting ← get maximum weighting for CCT from all chains
              containing it, or 1 if no weighting;
              /* All weightings are assumed to be less than or equal to one, and
                preferably for each chain, the weights are monotonic with the
                chain ordering, and the last weight for the chain being 1, e.g., for
                a chain of length four, the weights may be ¼, ⅓, ½, 1; for a
                chain of length five, the weights may be ⅕, ¼, ⅓, ½, 1 */
            DI.importance ← DI.importance + (CCT_weighting);
          }
          Else /* not all predecessors found for at least ordering; add nothing to
              importance */
        Else /* no ordering; so check to see if VI_{DI} has been encountered anywhere,
          including within the same retrieval */
            If [(there is a value (VJ_{DI}) of CCT for DJ) AND (the triple (VJ_{DI}, CCT,
              original generation date of VJ_{DI}) is not subsumed by one of the triples
              of Legitimate_Core_Values) AND [(VJ_{DI} = VI_{DI}) OR (a typographical
              variation of VJ_{DI} = VI_{DI})] then
              /* VI_{DI} has been encountered in a different situation */
            { /* So increase the importance of DI according to some function of the
                Core_client_data_characteristic_Types for MODEL[k] */
              DI.importance ← DI.importance + [1/(number of characteristic types
                  identified in Core_client_data_characteristic_Types)];
            }
  }
  Create_New_Watch_List_Member(DI);
}
/* Now determine a measurement indicative of identity theft according to MODEL[k] */
Time_period ← a MODEL[k] specific or user input time period;
Total_importance[i] ← 0;  //initializations
Count[i] ← 0;
    For each member (M) of Watch_List whose V_List has a value for the “recent_date” field that is
      within Time_Period do
    {
      Total_importance[i] ← Total_importance[i] + M.V_List.importance;
      Count[i] ← Count[i] + 1;
    }
  }
  RETURN(Total_importance, Count).
  } // END ID_Theft_Risk_Assessment
Create_New_Watch_List_Member(DI)
{
  Create a new pair (VL₀, DIL₀), wherein VL₀ is a V_List generated from the values of
    Core_client_data_characteristic_Types for D[i], and DIL₀ has D[i] as an element;
  VL₀.importance ← 0;
  VL₀.recent_date ← current date;
  Put (VL₀, DIL₀) on Watch_List;
}
```

What is claimed is:

1. A method for detecting identity theft, comprising:
(A) verifying a client's identity;
(B) receiving, from one or more informational sources, personal client information;
(C) presenting the personal client information to the client for obtaining corrected personal client information depending upon an extent of verification of the client's identity in step (A);
(D) subsequently, receiving additional personal client information from the one or more informational sources; and
(E) determining whether there is a discrepancy between the corrected personal client information and the additional personal client information, wherein the discrepancy indicates incorrect data in the additional personal client information; and
(F) providing the client with information related to identity theft when the discrepancy is determined to exist.

2. The method of claim 1, wherein the verifying step includes:
obtaining personal client information from a source different from the client;
formulating at least one question related to the personal client information, the at least one question unknown to the client;
subsequently, receiving a response to the at least one question from the client; and
using the response to verify the client's identity.

3. The method of claim 1, wherein the verifying step includes:
verifying the client wherein the extent of verification is at a first level for providing a first level of identity theft service; and
subsequently, second verifying the client at a second level for providing a second level of service, wherein the second level of service provides the client with access to information not provided to the client at the first level.

4. The method of claim 3, wherein the step of second verifying includes issuing a plurality of communications for contacting the client, wherein the communications request responses as to a validity of the client's identity.

5. The method of claim 4, wherein each of the communications request notification if the identity of the client is disputed.

6. The method of claim 1, wherein the verifying step includes:
obtaining a plurality of client contact informational items for contacting the client, wherein each of the client contact informational items is for contacting the client differently;
for at least one of the client contact informational items, a step of sending a communication to a client contact destination that is identified by the client contact informational item, wherein the communication requests a response for verifying the client's identity;
determining whether to provide the client with additional client related information depending on whether the client's identity is disputed in at least one response for verifying the client's identity; and
providing the client with additional client related information when the client's identity is not disputed by at least one received response for verifying the client's identity.

7. The method of claim 1, further including a step of second determining, when the discrepancy is determined to exist, a result indicative of a likelihood of identity theft occurring, the result being dependent upon an evaluation of the discrepancy.

8. The method of claim 7, wherein the step of second determining includes combining a plurality of weighted measurements, wherein for each of the weighted measurements, the measurement therefor is indicative of an occurrence of an identity theft related factor in the discrepancy, and the weight therefor is indicative of a relative effectiveness of the measurement for predicting whether identity theft is occurring or is likely to occur.

9. The method of claim 8, wherein the step of combining includes summing the weighted measurements.

10. The method of claim 8, wherein the weighted measurements are determined by a stochastic process receiving information related to a plurality of instances of information indicative of actual identity thefts.

11. The method of claim 1, further including a step of second receiving, when the discrepancy is determined to exist, more detailed personal client information from the one or more informational sources or additional informational sources for assisting with a determination of a likelihood of identity theft occurring.

12. The method of claim 11, wherein the step of second receiving includes selecting at least one type of client related information to retrieve for inclusion in the more detailed personal client information;
wherein the step of selecting is dependent upon at least one value of a result indicative of a likelihood of identity theft occurring, the result being dependent upon an evaluation of the discrepancy.

13. The method of claim 1, further including the steps of:
determining, for detecting a particular type of identity theft, corresponding core informational types;
wherein for detecting the particular type of identity theft, a change to data for one of the corresponding core informational types is necessary;
wherein the step (B) of receiving personal client information includes a step of receiving data for the corresponding core informational types for the particular type of identity theft;
wherein the step (D) of receiving the additional personal client information includes a step of receiving a subsequent instance of data for the core informational types;
wherein the step (E) includes determining the discrepancy by comparing the data for the corresponding core informational types with the subsequent instance of the data for the corresponding core informational types for determining a value, not known to legitimately identify the client; and
using the value in detecting identity theft in a subsequent performance of one of the steps (D) and (E).

14. The method of claim 13, further including receiving input from the client for selecting the particular type of identity theft for detecting from among a plurality of types of identity theft for detecting.
wherein for detecting the second type of identity theft, a change to data for one of the corresponding core informational types for the second type of identity theft is necessary.

15. The method of claim 14, further including receiving input for selecting a second type of identity theft different from the particular type of identity theft, wherein step (D) includes populating a corresponding collection of core client data types for detecting the second type of identity theft different from the particular type of identity theft.

16. The method of claim 1, wherein the steps (D) and (E) are iteratively performed, wherein during at least one of the iterations, an elapsed time between performances of the step (D) is changed.

17. The method of claim 16, further including a step of determining a change in the elapsed time according to a result indicative of a likelihood for identity theft occurring, the result being dependent upon an evaluation of the discrepancy.

18. A method for detecting identity theft, comprising:
(A) verifying a client's identity;
(B) receiving, from one or more informational sources, personal client information;
(C) presenting the personal client information to the client for obtaining corrected personal client information depending upon an extent of verification of the client's identity in step (A);
(D) subsequently, receiving additional personal client information from the one or more informational sources; and
(E) determining whether there is a discrepancy between the corrected personal client information and the additional personal client information, wherein the discrepancy indicates incorrect data in the additional personal client information;
(F) determining, when the discrepancy is determined to exist, a result indicative of a likelihood of identity theft occurring, the result being dependent upon an evaluation of the discrepancy, the evaluation including a step of combining a plurality of weighted measurements, wherein for each of the weighted measurements, the measurement therefor is indicative of an occurrence of an identity theft related factor in the discrepancy, and the weight therefor is indicative of a relative effectiveness of the measurement for predicting whether identity theft is occurring or is likely to occur;
(G) selecting data for requesting further more detailed information personal client information to be retrieved from the one or more informational sources or additional informational sources for assisting with identity theft analysis;
wherein the step of selecting is dependent upon at least one value of the result; and
(H) providing the client with information related to identity theft when the discrepancy is determined to exist.

19. The method of claim 18, further including a step of determining that a frequency of performing step (G) according to the result.

20. A method for detecting identity theft, comprising:
(A) verifying a client's identity;
(B) receiving, from one or more informational sources, personal client information;
(C) presenting the personal client information to the client for obtaining corrected personal client information depending upon an extent of verification of the client's identity in step (A);
(D) subsequently, receiving additional personal client information from the one or more informational sources; and
(E) determining whether there is a discrepancy between the corrected personal client information and the additional personal client information, wherein the discrepancy indicates incorrect data in the additional personal client information;
(F) determining, when the discrepancy is determined to exist, a result indicative of a likelihood of identity theft occurring, the result being dependent upon an evaluation of the discrepancy, the evaluation including a step of combining a plurality of weighted measurements, wherein for each of the weighted measurements, the measurement therefor is indicative of an occurrence of an identity theft related factor in the discrepancy, and the weight therefor is indicative of a relative effectiveness of the measurement for predicting whether identity theft is occurring or is likely to occur; and
(G) providing the client with information related to the result.

21. A method for detecting identity theft, comprising:
(A) verifying a client's identity;
(B) receiving, from one or more informational sources, personal client information;
(C) presenting the personal client information to the client for obtaining corrected personal client information depending upon an extent of verification of the client's identity in step (A);
(D) subsequently, receiving additional personal client information from the one or more informational sources; and
(E) determining whether there is a discrepancy between the corrected personal client information and the additional personal client information, wherein the discrepancy indicates incorrect data in the additional personal client information;
(F) selecting data for requesting further more detailed information personal client information to be retrieved from the one or more informational sources or additional informational sources for assisting with identity theft analysis;
wherein the step of selecting is dependent upon at least one value of the result; and
(G) providing the client with information related to identity theft after the discrepancy is determined to exist.

22. A method for detecting identity theft, comprising:
receiving, from one or more informational sources, personal information identifying a client;
detecting one or more discrepancies between the personal information, and client information known to be correct for the client;
determining a likelihood that a theft of the client's identity is occurring or has occurred;
wherein the step of determining includes determining one or more of:
(d) a number of the discrepancies between the personal information and the client information;
(e) whether a first instance of a value of the personal information, detected when determining at least one of the discrepancies, is a typographical variation of a second instance of the value, and wherein the first and second instances are not a result of a common act by the client; and
(f) whether there is a common value, detected in first and second records of the personal information, wherein:
(i) the common value is not correct for the client, and
(ii) the first and second records are not a result of a single act by the client.

23. The method of claim 22, wherein the step of determining includes determining a number of the discrepancies between the personal information and the client information.

24. The method of claim 22, wherein the step of determining includes determining whether a first instance of a value of the personal information, detected when determining at least one of the discrepancies, is a typographical variation of a second instance of the value, and wherein the first and second instances are not a result of a common act by the client.

25. The method of claim 22, wherein the step of determining includes determining whether there is a common value, detected in first and second records of the personal information, wherein:
(i) the common value is not correct for the client, and
(ii) the first and second records are not a result of a single act by the client.

26. A method for detecting identity theft, comprising:
(A) first receiving information for identifying a client;
(B) receiving from one or more informational sources, personal client information of the client's identity;
(C) presenting the personal client information to the client for obtaining corrected personal client information;
(D) receiving additional personal client information from the one or more informational sources; and
(E) determining whether there is a discrepancy between the corrected personal client information and the additional personal client information, wherein the discrepancy indicates incorrect data in the additional personal client information;
(F) determining, when the discrepancy is determined to exist, a result indicative of a likelihood of identity theft occurring, the result being dependent upon an evaluation of the discrepancy, the evaluation including a step of combining a plurality of weighted measurements, wherein each of the weighted measurements is indicative of a relative effectiveness for predicting whether identity theft is occurring or is likely to occur, and the measurement therefor is indicative of an occurrence of an identity theft related factor in the discrepancy;
(G) receiving, for at least one value of the result, further more detailed personal client information from the one or more informational sources or additional informational sources for assisting with identity theft analysis;
(H) determining a further likelihood of the identify theft occurring using the more detailed information; and
(I) providing the client with information related to identity theft, at least one of the transmissions occurring after determining the further likelihood.

27. The method of claim 26, wherein the step of receiving includes selecting data for requesting the further more detailed personal client information;
wherein the step of selecting is dependent upon at least one value of the result.
